(19) United States
(12) Patent Application Publication
(10) Pub. No.: US 2026/0304319 A1
(43) Pub. Date: Oct. 1, 2026

(54) SEMI-STATIC INDICATION OF COMMUNICATION MODES

(71) Applicant: QUALCOMM Incorporated, San Diego, CA (US)

(72) Inventors: Ahmed ELSHAFIE, San Diego, CA (US); Wei YANG, San Diego, CA (US); Huilin XU, Temecula, CA (US); Yuchul KIM, San Diego, CA (US); Chao WEI, Beijing (CN); Zhikun WU, Beijing (CN); Linhai HE, San Diego, CA (US)

(21) Appl. No.: 19/100,924

(22) PCT Filed: Sep. 29, 2022
(86) PCT No.: PCT/CN2022/122534

§ 371 Date: Feb. 3, 2025

(51) Int. Cl. H04W 52/02; H04L 1/1812; H04W 24/08; H04W 52/36; H04W 68/06; H04W 74/0833; H04W 76/28

(52) U.S. Cl. CPC H04W 52/0235; H04L 1/1812; H04W 24/08; H04W 52/365; H04W 68/06; H04W 74/0833; H04W 76/28

(57) ABSTRACT

A method for wireless communication at a user equipment (UE) and related apparatus are provided. In the method, the UE receives an indication to use one or more communication modes from a network entity. Each of the one or more communication modes may be associated with a configuration of at least one of a first radio and a second radio of the UE, and the second radio may have a lower power consumption than the first radio. The UE further monitors for communication from the network entity according to at least one of the one or more communication modes.

### TECHNICAL FIELD

The present disclosure relates generally to communication systems, and more particularly, to wireless communication including semi-static indication of communication modes.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include a first radio, a second radio, a memory, and at least one processor coupled to the memory. Based at least in part on information stored in the memory, the at least one processor may be configured to receive an indication to use one or more communication modes from a network entity. Each of the one or more communication modes may be associated with a configuration of at least one of the first radio and the second radio of the UE. The at least one processor may be further configured to monitor for communication from the network entity according to the one or more communication modes.

In an aspect of the disclosure, a method, a computer-readable medium, and an apparatus are provided for wireless communication at a network entity. The apparatus may include a memory and at least one processor coupled to the memory. Based at least in part on information stored in the memory, the at least one processor may be configured to transmit, to a UE, an indication to use one or more communication modes. Each of the one or more communication modes may be associated with a configuration of at least one of a first radio and a second radio of the UE. The second radio has a lower power consumption than the first radio. The at least one processor is further configured to transmit communication to the UE according to a corresponding communication mode in the one or more communication modes at a time the communication is transmitted to the UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of a discontinuous reception (DRX) cycle in wireless communication.

FIG. 4B is a diagram illustrating a configuration in which a network sends both a low-power wake-up signal (LP-WUS) and a physical downlink control channel (PDCCH) wake-up signal (WUS) for UEs in wireless communication.

FIG. 5A is a diagram illustrating a UE with a high-power radio and a low-power radio.

FIG. 5B is a diagram illustrating a UE with shared radio component(s).

FIG. 6 is a diagram illustrating the operation of a WUS in wireless communication.

FIG. 7 is a diagram illustrating an example power state in a slot in wireless communication.

FIG. 8 is a diagram illustrating an example UE power consumption at state transition in wireless communication.

FIGS. 9A and 9B are diagrams illustrating different transition times for the WUS in wireless communication.

FIG. 9C is a diagram illustrating preamble signals and WUS in wireless communication.

FIG. 9D is a diagram illustrating low power synchronization signal (LP-SS) and WUS in wireless communication.

FIG. 9E is a diagram illustrating the clock frequency drift in wireless communication.

FIG. 10 is a first call flow diagram illustrating a method of wireless communication in accordance with various aspects of the present disclosure.

FIG. 11 is a second call flow diagram illustrating a method of wireless communication in accordance with various aspects of the present disclosure.

FIGS. 12A, 12B, and 12C are diagrams illustrating various sequences of the communication modes in accordance with various aspects of the present disclosure.

FIGS. 13A, 13B, and 13C are diagrams illustrating various sequences of the communication modes in accordance with various aspects of the present disclosure.

FIG. 14 is the first flowchart illustrating methods of wireless communication at a UE in accordance with various aspects of the present disclosure.

FIG. 15 is the second flowchart illustrating methods of wireless communication at a UE in accordance with various aspects of the present disclosure.

FIG. 16 is the first flowchart illustrating methods of wireless communication at a network entity in accordance with various aspects of the present disclosure.

FIG. 17 is the second flowchart illustrating methods of wireless communication at a network entity in accordance with various aspects of the present disclosure.

FIG. 18 is a diagram illustrating an example of a hardware implementation for an example UE.

FIG. 19 is a diagram illustrating an example of a hardware implementation for an example network entity.

### DETAILED DESCRIPTION

A UE may be configured with resources to monitor for a low power wake-up signal (LP-WUS) and wake up the main radio when actual data communication is needed. Since the LP-WUS consumes very low power, the UE may reduce the total power consumption by avoiding unnecessary wake-up of the main radio, which is very costly in power consumption. The UE may allow frequent wake-up signal (WUS) monitoring to reduce the average latency. Aspects presented herein focus on the sequential indication of communication modes (or power saving states, sleeping states, data traffic modes, or modes) related to the WUS for a UE to operate in a more semi-static manner with known patterns of configuration changes. In addition, aspects of the present disclosure include the indication of operating certain components, such as a low noise amplifier (LNA) in a wake-up radio (WUR), or certain bandwidths for the UE. The indication may include a core bandwidth or frequency range for the WUR. In some aspects, the UE may receive an indication to use one or more communication modes from a network entity. Each of the communication modes may be associated with a configuration of at least one of a first radio and a second radio of the UE. The second radio may have a lower power consumption than the first radio. The UE may monitor for communication from the network entity according to the one or more communication modes. By operating according to the one or more communication modes, the UE may use a reduced amount of power to monitor for and receive a specified signal (e.g., LP-WUS) relative to the higher amount of power to monitor for and receive the higher power signal. Thus, the overall power efficiency of wireless communication may be improved.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, e.g., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

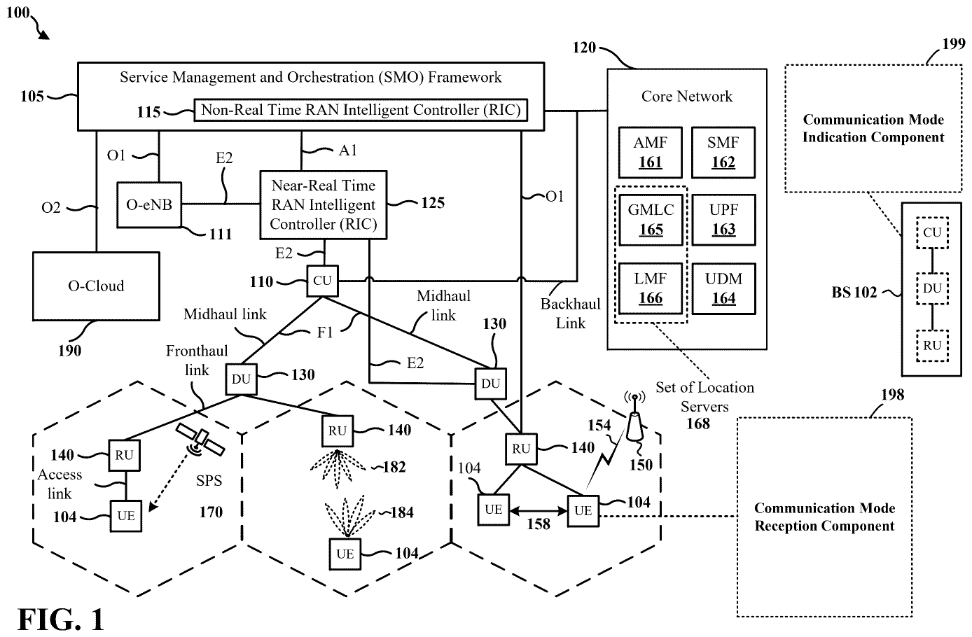

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, e.g., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (e.g., Central Unit-User Plane (CU-UP)), control plane functionality (e.g., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a communication mode reception component 198 that is configured to receive, from a network entity, an indication to use one or more communication modes, wherein each of the one or more communication modes is associated with a configuration of at least one of a first radio and a second radio of the UE, the second radio having a lower power consumption than the first radio; and monitor, according to at least one of the one or more communication modes, for communication from the network entity. In some aspects, the communication mode reception component 198 may be configured to receive a configuration including a sequence of communication modes from a network entity. Each of the communication modes may be associated with a time interval, and may be associated with a different power state of the UE. The communication mode reception component 198 may be further configured to monitor for communication from the network entity according to the sequence of communication modes. In certain aspects, the base station 102 may include a communication mode indication component 199 that is configured to transmit, to a UE, one or more communication modes, wherein each of the one or more communication modes is associated with a configuration of at least one of a first radio and a second radio of the UE, the second radio having a lower power consumption than the first radio; and transmit communication to the UE according to a corresponding communication mode in the one or more communication modes at a time the communication is transmitted to the UE. In some aspects, the communication mode indication component 199 may be configured to transmit a configuration including a sequence of communication modes to a UE. Each of the communication modes may be associated with a time interval, and may be associated with a different power state for the UE. The communication mode indication component 199 may be further configured to transmit communication to the UE according to a corresponding communication mode in the sequence of communication modes at a time the communication is transmitted to the UE. Although the following description may be focused on 5G NR, the concepts described herein may be applicable to other similar areas, such as LTE, LTE-A, CDMA, GSM, and other wireless technologies.

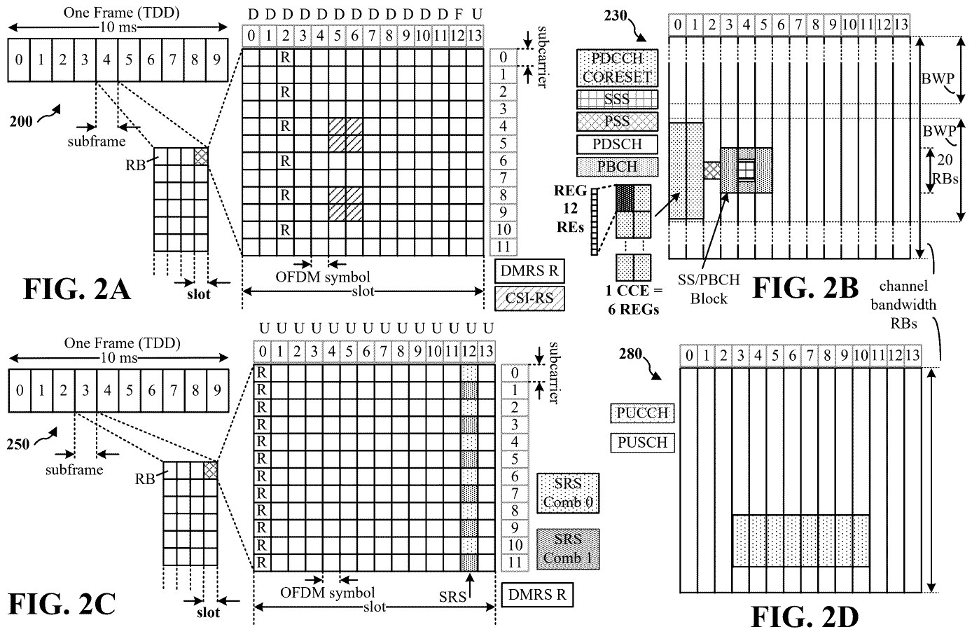

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology u=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (e.g., one or more HARQ ACK bits indicating one or more ACK and/or negative ACK (NACK)). The PUSCH carries data, and may additionally be used to carry a buffer status report (BSR), a power headroom report (PHR), and/or UCI.

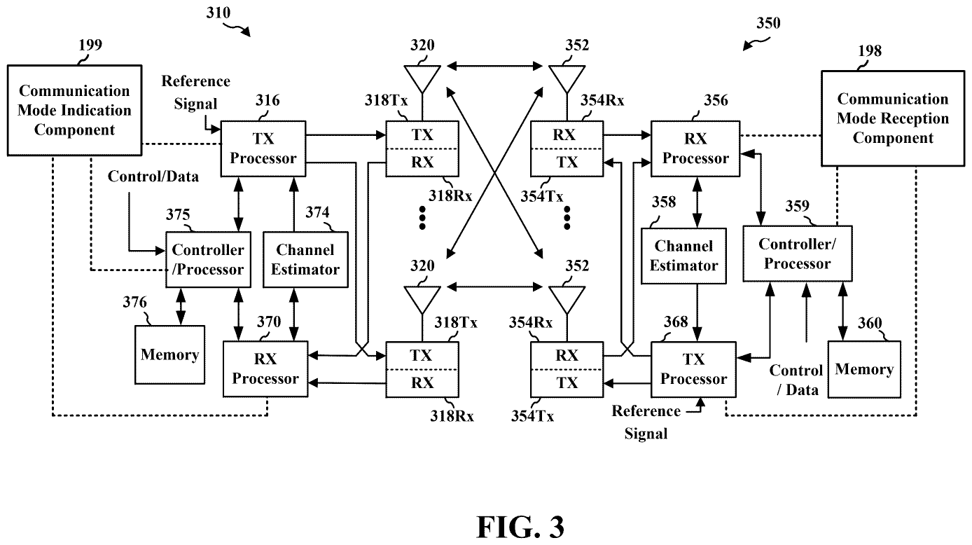

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the communication mode reception component 198 of FIG. 1.

At least one of the TX processor 316, the RX processor 370, and the controller/processor 375 may be configured to perform aspects in connection with the communication mode indication component 199 of FIG. 1.

In RRC idle and inactive states, radio resource management (RRM) and paging consume significant UE power. For example, in RRM, the UE periodically performs layer 3 reference signal received power (L3-RSRP) measurements on SSBs transmitted by a serving cell of the UE and neighbor cells of the UE. Such L3-RSPRP measurements consume power. In another example, in paging, the UE periodically monitors a paging occasion (PO) during each idle discontinuous reception (I-DRX) cycle. In a DRX mode, the UE may monitor a PDCCH channel discontinuously using a sleep and wake cycle, e.g., DRX OFF durations and DRX ON durations. When the UE is in an RRC connected state, the DRX may also be referred to as Connected Mode DRX (C-DRX). If the UE is in an RRC idle state, the DRX may be referred to as I-DRX. In a non-DRX mode, the UE monitors for PDCCH in each subframe to check whether there is downlink data available. Continuous monitoring of the PDCCH uses more battery power at the UE, and DRX conserves battery power at the UE.

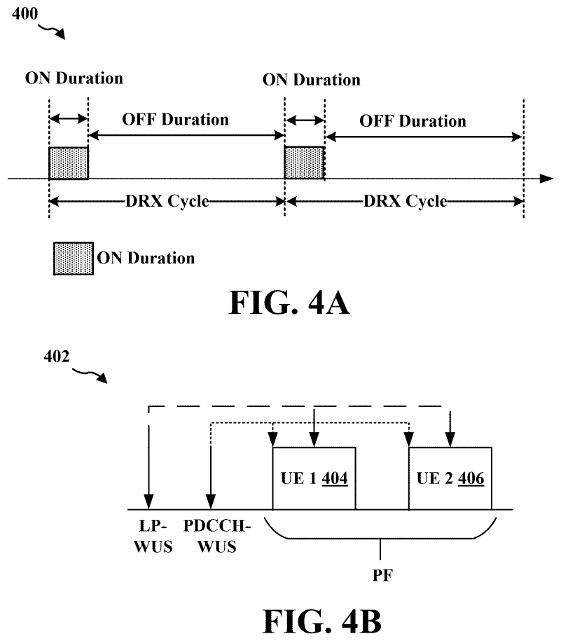

FIG. 4A illustrates an example of a DRX cycle 400 including periodic ON durations during which the UE monitors for PDCCH and OFF durations during which the UE may not monitor for the PDCCH. The OFF duration may be referred to as a DRX opportunity, in some aspects. During the OFF duration, the UE does not monitor for PDCCH. The UE may enter a sleep mode or a low power mode in which the UE minimizes power consumption by shutting down an RF function without detecting communication from the base station.

The base station may send a wake-up signal (WUS) to a UE in advance of a PO when the base station will transmit communication to the UE. If the UE receives a WUS, the UE may wake-up by preparing to receive the communication during the PO. If the UE does not receive a WUS, the UE may return to the sleep mode. A UE may be configured with resources to monitor for the WUS. When configured with such resources, the UE wakes up a configurable amount of time before a start of a long DRX cycle and checks, e.g., monitors, for the WUS. If the UE does not receive the WUS, the UE returns to sleep for the next long DRX cycle. The use of WUSs may help to reduce power consumption for UEs, e.g., by allowing the UE to return to the sleep mode without monitoring for additional signaling. In some configurations, a WUS may be transmitted over the PDCCH (such a wakeup signal may be referred to as a PDCCH-WUS).

In some configurations, a UE may be equipped with a low power wakeup radio (LP-WUR) that utilizes less battery power than other radios (e.g., a main radio) of the UE. In an example, the LP-WUR may utilize less than 1 mA. The LP-WUR may be configured to receive a low power wakeup signal (LP-WUS). A UE that utilizes the LP-WUS for wakeup purposes may consume less power than a UE that utilizes the PDCCH-WUS for wakeup purposes. The LP-WUS may utilize a simplified modulation scheme in comparison to a WUS (e.g., which may be referred to as a higher power WUS). As an example, the LP-WUS may be based on an on-off keying (OOK) modulation scheme. The OOK modulation scheme may lead to a smaller a payload size for an LP-WUS.

FIG. 4B illustrates a configuration 402 in which a network sends both an LP-WUS and a PDCCH-WUS for UEs, e.g., without distinguishing between UEs that are closer to a cell edge and UEs that are closer to a base station. In the configuration 402, a base station (e.g., the base station 102, the base station 310) transmits the LP-WUS and the PDCCH-WUS to a first UE 404 and a second UE 406 to indicate that the base station will send information for the UEs in a paging frame (PF). The first UE 404 and the second UE 406 may each determine which type of WUS to utilize, e.g., for a particular paging occasion. For instance, the first UE 404 may decide to utilize the LP-WUS and the second UE 406 may decide to utilize the PDCCH-WUS. In an example, the first UE 404 and the second UE 406 may select the LP-WUS or the PDCCH-WUS based upon a condition experienced at the UE, such as a measured reference signal received power (RSRP) relative to an RSRP threshold. If the UE measures an RSRP for a signal received from the base station that is equal to or above the RSRP threshold, the UE may monitor for the LP-WUS and not the PDCCH-WUS. If the UE measures an RSRP that is below the RSRP threshold, the UE may instead monitor for the PDCCH-WUS. In some aspects, the UE may determine whether to monitor for the LP-WUS or the PDCCH-WUS based on a location of the UE within a cell, e.g., monitoring for the LP-WUS if the UE is closer to a cell center and monitoring for the PDCCH-WUS if the UE is closer to a cell edge. In some aspects, the UE may determine whether to monitor for the LP-WUS or the PDCCH-WUS based on a mobility state of the UE, e.g., monitoring for the LP-WUS if the UE has a low mobility or is stationary, and monitoring for the PDCCH-WUS if the UE has a higher mobility state.

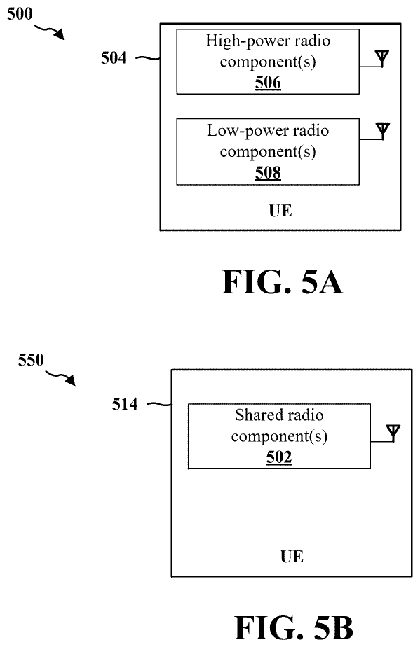

As illustrated in the diagram 500 in FIG. 5A, in some aspects, the UE 504 may include separate radios, e.g., different components, that the UE uses for the different measurements. For example, the UE 504 may use the high-power radio component(s) 506 for serving cell measurements and/or serving beam measurements. The UE 504 may use a different radio, e.g., the low-power radio component(s) 508 to perform measurements of the neighbor cells and/or non-serving beams.

In other aspects, as shown in the diagram 550 in FIG. 5B, the UE 514 may have shared radio component(s) 502 that are used for both the serving cell and the neighbor cells measurements and/or for the serving beam and non-serving beam measurements. However, different measurement configurations, e.g., different parameters, may be used by the shared radio component 502 to perform the different measurements.

In some aspects, the high-power radio components 506 or the configuration for the serving cell/serving beam measurements performed by the shared radio component 502 may be more accurate, provide a higher level of gain, be more complex, and/or consume more power at the UE. The low-power radio component(s) 508 or the configuration for the neighbor cell/non-serving beam measurements performed by the shared radio component 502 may be less accurate, provide a lower level of gain, be less complex, and/or consume less power at the UE.

An LP-WUR may be a companion receiver monitoring a wake-up signal with very low power, e.g., less power than the main radio, while the main radio is in a deep sleep state. The LP-WUR may wake up the main radio when actual data communication is needed. The LP-WUR consumes low power by design. It may be powered separately by less power-hungry blocks. An LP-WUR may reduce the total power consumption as it can avoid unnecessary wake-up of the MR, which is very costly in terms of power consumption. An LP-WUR may reduce the average latency as it allows more frequent WUS monitoring due to its low power consumption.

Due to its lower power consumption and lower latency, an LP-WUR may be used in various applications that use low power (LP) or low latency (LL). Example use cases with LP preferences may include applications for periodic sensing or metering. Example use cases with LP preferences may include actuator control, on-demand sensing applications, and on-demand location tracking.

Each LP-WUS occasion may be associated with one or more POs. Each LP-WUS Tx may indicate whether the UEs in the associated PO(s) have a new page, and the LP-WUS may further include indications for subgroups in a PO (as permanent equipment identifier (PEI)). A UE may wake up its MR for paging after receiving a positive indication. The same non-access stratum (NAS) and access stratum (AS) signaling support for PEI may be reused.

However, the LP-WUS may have shortcomings when used alone. For example, an LP-WUS may need a high level of repetition to match the same coverage of the PDCCH. Thus, it may be resource expensive in situations with many UEs having high mobility and changing serving cells frequently. Also, an LP-WUS may be less efficient in supporting large payloads due to the modulation and receiver architecture it uses, such as when the LP-WUS is configured to have the same coverage as the PDCCH. Joint configuration with PEI may help to improve efficiency. Different options may be designed depending on whether an LP-WUS is used by each UE in the cell or a whether the LP-WUS is configured for full coverage.

The LP-WUS may be targeted for paging reception. A UE may use another source, a low power reference signal (LP-RS), to perform RRM and true or false (T/F) tracking, and perform resynchronization. As used on PSS/SSS with 5 milliseconds of periodicity may result in 1 second of resynchronization time, a new reference signal, ReSynchronization Signal (RSS), enables quicker acquisition. An LP-WUR supporting OFDM waveform, may use such an RSS or even a more robust synchronization signal one given the LP-WUR's computational capability and receiver.

The LP-WUR that uses the RSS may include an LP-WUR supporting an OOK waveform and LP-WUR supporting OFDM waveform. In one example, for LP-WUR supporting OOK waveform, an LP-RS that is based on the OOK for T/F synchronization may be received by the LP-WUR that has a bandwidth of less than 5 MHz and a Noise Figure (NF) larger than 7 dB. In another example, for LP-WUR supporting OFDM waveform (e.g., Zadoff-Chu (ZC) sequence-based WUS), an LP-RS may be received by the LP-WUR that has a bandwidth of 1 MHz and an NF of 5 dB. In another example, for LP-WUR supporting OFDM waveform, an LP-RS may be needed for the LP-WUR that has a bandwidth of 5 MHz and an NF of 5 dB.

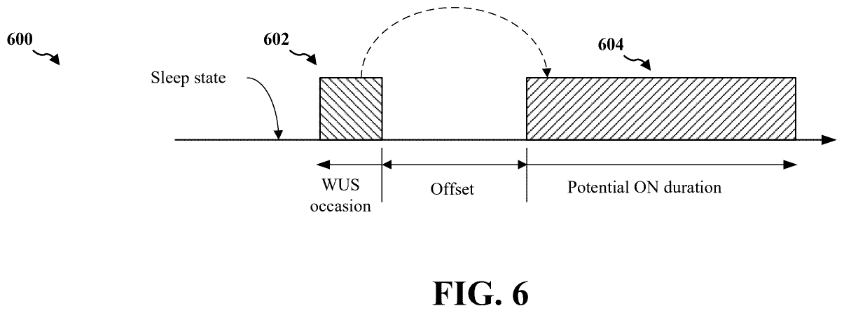

As noted above, the use of a WUS may improve the power efficiency during C-DRX operation. For example, a WUS may reduce the chance of unnecessary wake-up in DRX operations. PDCCH may be monitored during the ON duration when a corresponding WUS is detected and/or the WUS indicates the UE to wake up. Otherwise, the ON duration can be skipped and the UE may remain in sleep for power saving. PDCCH-based WUS has been adopted as a power saving mechanism. PDCCH-based WUS can be transmitted before the ON duration by an offset. FIG. 6 is a diagram 600 illustrating the operation of a WUS in wireless communication. As shown in FIG. 6, a WUS occasion 602 (e.g., a PDCCH-based WUS) may be transmitted before the potential ON duration 604 by an offset.

A UE may have different power consumption models. The UE power consumption model may be a simple model that reflects a slot-based average power or a detailed model that captures various aspects of wireless communication. The UE power consumption model may capture various characteristics including, but not limited to, power states, state transition energy and time, power consumption scaling, and power consumption for RRM measurements.

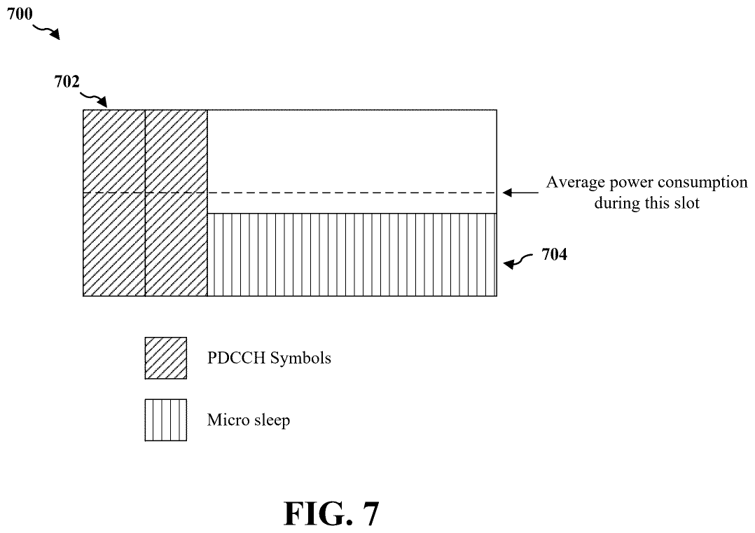

The power state may reflect a configuration for power consumption and may be specified on a per-slot basis. FIG. 7 is a diagram 700 illustrating an example power state in a slot in wireless communication. As shown in FIG. 7, the slot may include two PDCCH symbols 702, and the rest of the slot may be in a micro sleep state 704. The power level of this slot may be the average power consumption of this slot, as shown by the dashed line of FIG. 7. Example power consumption models of a UE operating in FR1 and FR2 are shown in Table 2 and Table 3, respectively.

TABLE 2
UE power consumption model for FR1

| Power | | Relative |
|---|---|---|
| State | Characteristics | Power |
| Deep | Time interval for the sleep is larger than the | 1 (optional |
| Sleep | total transition time entering and leaving this | 0.5) |
| | state. Accurate timing may not be maintained. | |
| Light | Time interval for the sleep is larger than the | 20 |
| Sleep | total transition time entering and leaving this | |
| | state. | |
| Micro | Immediate transition is assumed for power | 45 |
| Sleep | saving study purpose from or to a non-sleep | |
| | state | |
| PDCCH | No PDSCH and same-slot scheduling: this | 100 |
| only | includes time for PDCCH decoding and any | |
| | micro-sleep within the slot. | |
| SSB or | SSB can be used for fine time-frequency sync. | 100 |
| CSI-RS | And RSRP measurement of the | |
| proc. | serving/camping cell. TRS is the considered | |
| | CSI-RS for sync. FFS the power scaling for | |
| | processing other configurations of CSI-RS. | |
| PDCCH + | PDCCH + PDSCH. ACK/NACK in long | 300 |
| PDSCH | PUCCH is modeled by UL power state | |
| UL | Long PUCCH or PUSCH | 250 (0 |
| | | dBm) |
| | | 700 (23 |
| | | dBm) |

TABLE 3
UE power consumption model for FR2

| Power | | Relative Power | |
|---|---|---|---|
| State | Characteristics | FR1 | FR2 |
| PDCCH | No PDSCH and same-slot | 100 | 175 |
| only | scheduling; this includes time | | |
| | for PDCCH decoding and any | | |
| | micro-sleep within the slot | | |
| SSB or | SSB can be used for fine time- | 100 | 175 |
| CSI-RS | frequency sync. And RSRP | | |
| proc. | measurement of the | | |
| | serving/camping cell. TRS is the | | |
| | considered CSI-RS for sync. | | |
| | FFS the power scaling for | | |
| | processing other configuration | | |
| | of CSI-RS (Note 2 SSBs in a | | |
| | slot for the ref. confg.) | | |
| PDCCH + | PDCCH + PDSCH. | 300 | 350 |
| PDSCH | ACK/NACK in long PUCCH is | | |
| | modeled by UL power state. | | |
| UL | Long PUCCH or PUSCH | 250 (0 | 350 |
| | | dBm) | (FFS Tx |
| | | 700 (23 | power |
| | | dBm) | level) |

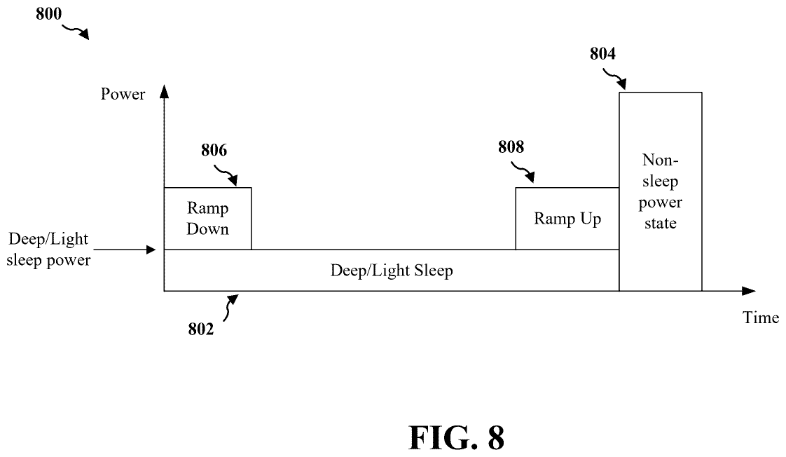

The state transition energy and transition time reflect the energy and time to turn on/off component blocks for the transition between different power states (e.g., from a non-sleep state to/from a sleep state). The deeper the sleep state is, the longer the transition time is to transition to a non-sleep state. FIG. 8 is a diagram 800 illustrating an example UE power consumption at state transition in wireless communication. As shown in FIG. 8, when a UE transitions from a deep/light sleep state 802 to a non-sleep power state 804, additional transition energy and transition time may be used for a ramp up period 808. Additional transition energy and transition time may be used for a ramp down period 806 when transiting from a non-sleep power state to a deep/light sleep state.

Table 4 shows example transition energy and transition time for the transition from different sleep states to a non-sleep power state. According to Table 4, when a DRX OFF duration is 0 to less than 6 ms, a UE can perform microsleep (e.g., and not the deep sleep or micro sleep) and is expected to do so. When a DRX OFF duration is between 6 ms and 20 ms, a UE can perform light sleep mode or microsleep mode. When a DRX OFF duration is more than 20 ms, a UE can perform any type of sleep mode and it is better for the UE to perform a deep sleep mode for improved power reservation.

TABLE 4
UE power consumption during a state transition

| | Additional transition | | |
|---|---|---|---|
| | energy (relative | | |
| Sleep Type | power x ms) | Total transition time | |
| Deep sleep | 450 | 20 | ms |
| Light sleep | 100 | 6 | ms |
| Micro sleep | 0 | 0 | ms* |

An immediate transition may be assumed for power saving study purpose from or to a non-sleep state

A WUR may be used during a connected mode, where a UE may put the MR into different sleep types (e.g., deep sleep, light sleep, or micro sleep) and monitor the wake-up signal using the WUR. Although only three sleep modes are presented to illustrate the concept, the various power modes may include any number of different modes. The present disclosure provides multiple energy (e.g., power) saving and/or communication modes (e.g., communication modes associated with a power saving mode, sleeping mode, predicted/expected traffic for transmission or reception by the UE) for radios at a UE having different power consumptions, e.g., a low power radio and a main radio that has a higher power consumption than the low power radio. The present disclosure provides multiple sleep/energy saving/communication modes for both a low power radio (e.g., which may be referred to as a wake-up radio (WUR) a low power WUR (LP-WUR), etc.) and another radio having a higher power consumption (e.g., which may be referred to as a main radio (MR) a higher power radio, etc.). Based on these sleep/energy saving/communication modes, the UE may use specific hardware (HW) components or processing units to perform various tasks, such as monitoring PDCCH-based WUS, OOK-based signals (e.g., OOK-based WUS), or sequence-based signals (e.g., sequence-based WUS), or monitoring dense communication, or a combination of these tasks. The present disclosure further provides for a sequential indication of communication modes (or power saving states, sleeping states, data traffic modes, or modes) related to the WUS for a UE to operate in a more semi-static manner with known patterns of configuration changes. For example, aspects presented herein provide for a configuration or other indication of a sequence of power modes for the UE to apply over a period of time. In addition, aspects of the present disclosure include the indication of operating certain components, such as a low noise amplifier (LNA) in a wake-up radio (WUR), or certain bandwidths for the UE. The indication may include a core bandwidth or frequency range for the WUR.

In some aspects, the multiple energy (power) modes or communication modes (a communication mode may be associated with a power mode, sleeping mode, predicted/expected traffic for transmission or reception by the UE) for the LP-WUR and the MR may be defined. The power modes may include the three sleep types (i.e., deep sleep, light sleep, and micro sleep) in Table 4. Table 4 can be modified to include more states such as OFF state, ultra-low-power state, or very low power state. These power modes may be used for the MR and not the WUR, for the WUR and not the MR, or for both the MR and the WUR. The energy modes, sleep modes, or communication modes may include additional modes (such as an OFF mode, a very low power mode, or an ultra-low power mode) in addition to the deep sleep, light sleep, and micro sleep modes. In some aspects, power modes may include joint modes (e.g., combinations of an MR power mode and a WUR power mode). Each of these modes and joint modes may be associated with certain configurations, tasks, or capabilities of the MR and the WUR. Switching from one mode to another mode may be done through, e.g., triggered at the UE by, the layer 1 (L1) signaling, the layer 2 (L2) signaling, the layer 3 (L3) signaling. The signaling, or a combination of the signaling may be received on at least one of the MR and the WUR.

In some examples, the power mode at the UE might include at least one of battery state or charging rate at the UE or discharging (power consumption) rate at the UE. In some examples, based on at least one of the predicted energy charging rate, the predicated energy discharging rate, and the predicted energy states, the UE can indicate the communication mode at a time, the communication mode at a time duration, the communication mode until the next indication, a sequence of communication modes, and the desired sleeping modes at each radio (e.g., WUR and MR). In some examples, the UE may report these characteristics in addition to the suggested communication mode pattern/sequence, and the base station may decide the final communication mode sequence. In some examples, based on updated measurements on energy and DL and UL traffic, and desired sleeping modes, the UE or the base station may indicate a change of one communication mode to another communication mode or a change of one sequence of communication modes to another sequence of communication modes. The indication of a desired communication mode at a certain time, a desired communication mode during a certain time duration, or a desired sequence/pattern of communication modes at a time or during a time duration can be done through L1/L2/L3 signaling or user-assistance information (UAI). The indication may also be piggybacked on or multiplexed with one or more of BSR, scheduling request (SR), CSI, HARQ-ACK, PHR, or random-access channel (RACH) messages. The indication may include the durations and the corresponding communication mode during each duration. The base station may receive the information and determine the communication mode at a certain time, the communication mode at a certain time duration, or a sequence of communication modes and their durations, which may be configured through L1/L2/L3 signaling. During a communication mode, the UE may request to change the communication mode through L1/L2/L3 signaling, UAI, or an indication piggybacked on or multiplexed with one or more of BSR, SR, CSI, HARQ-ACK, PHR, or RACH messages.

In some examples, the UE may indicate the desire to change a communication mode sequence. The base station may change a communication mode during that communication mode using L1/L2/L3 signaling. The base station may change the communication mode sequence based on at least one of a UE's energy information report (e.g., energy state, charging rate, discharging rate measurements and predictions), a UE's suggested sleep mode/state report (e.g., sleep mode for each radio during each interval), a UE's suggested communication mode and its duration or a sequence of communication modes and their durations (which takes into account the energy information report and the desired sleep state report), a UE's expected/predicted UL traffic, its priorities (e.g., L1 and L2 priorities) and QoS, UE's expected/predicted DL traffic, its priorities (e.g., L1 and L2 priorities) and QoS (which is known at the base station). Similar principles as those described above may be applicable to UE to UE communication or programable logic control (PLC) to UE communication in sidelink.

An energy mode of the WUR may be based on, or correspond to, a configuration, a task or a capability of the WUR. For example, an energy mode of the WUR may include one or more of: using one or more of active radio frequency (RF) components, such as the low noise amplifier (LNA) or the power amplifier (if the WUR has the transmission capability) by the WUR, using one or more hardware (HW) components that could process complex signals, such as time domain complex sequencing or frequency domain discrete Fourier transform (DFT) or a combination thereof, using one or more HW components that can process polar decoding, such as PDCCH-based WUS, a faster capability to process time domain or frequency domain (or a combination of time and frequency domain) signals, which may be used to process more signals or shorten the DRX cycles, a time to be taken to process one or more of decoding or detection of the WUS or one or more of LP-RS, LP-SS, LP-sync-preamble signal processing, using of a larger bandwidth (BW) or a smaller BW, processing LP-WUS only, one or more of LP-RS, LP-SS, LP-sync-preamble signal only, or both LP-WUS and one or more of LP-RS, LP-SS, LP-sync-preamble signal, using a lower or higher time duration and frequency allocation and periodicity configuration, using a larger or a smaller subcarrier spacing (SCS), setting radio resource management (RRM) measurements of a serving cell or nearby cells (for at least one RRM measurement type of the inter-frequency type or the intra-frequency type), and monitoring for one or more of a synchronization signal block (SSB), a system information change, or a system information block (SIB) signal.

If the WUR is used by the UE during the connected mode to monitor for a wake-up signal, the MR could be in a sleep state 0 (i.e., an OFF state, a very low power state, or an ultra-low power state), a state 1 (i.e., a deep sleep state), a state 2 (i.e., a light sleep state), or a state 3 (i.e., a micro sleep state), while the WUR may be in one of these states.

The base station may indicate to the UE to transition to a a particular joint power mode, e.g., with a mode or configuration for each of the MR and the WUR.

In one example, the base station and the UE may understand, based on signaling through RRC, MAC-CE or DCI or based on a rule or definition, to use a PDCCH-based WUS and not a LP-WUS. The base station may send the PDCCH signal (e.g., the PDCCH based WUS rather than the LP-WUS), and the UE may monitor for the PDCCH based WUS rather than the LP-WUS. In another example, the base station may send both types of WUS (e.g., LP-WUS and PDCCH-based WUS) once the UE has indicated a move to a new state compatible with both types of WUS. The use of both signals may be indicated in signaling (e.g., RRC, MAC-CE, and/or DCI) or may be based on a rule in response to the UE's move to the new state.

The type of the PDCCH signal transmitted by the base station and monitored by the UE may be a function of a joint state of the WUR and the MR. For example, once a UE is signaled use a light sleep saving mode (e.g., which may be associated with the MR and not the WUR), is the signaling may implicitly indicate to the UE that the MR is to be used for determining the PDCCH-based WUS.

In one configuration, a UE may report a gap time information for the transitions between various states on each radio (i.e., MR and WUR). The base station may configure the UE to operate on, e.g., perform, a particular transition state. The base station may also define a sequence of states, and let the UE determine its own transition time between the states and the transition time between the time an LP-WUS is received on the WUR to the time when the MR is ON or is ready to monitor the PDCCH occasions. For example, assuming a UE is monitoring for a WUS using a WUR while the MR connected mode, the base station may indicate in the LP-WUS for the UE to wake up (e.g., wake up the MR from a sleep mode) to monitor for additional downlink signaling in the next DRX active time. The gap in time between receiving this LP-WUS to the wake up may be a function of the current MR sleeping mode or communication mode or of the joint communication mode or sleeping mode of the MR and the WUR.

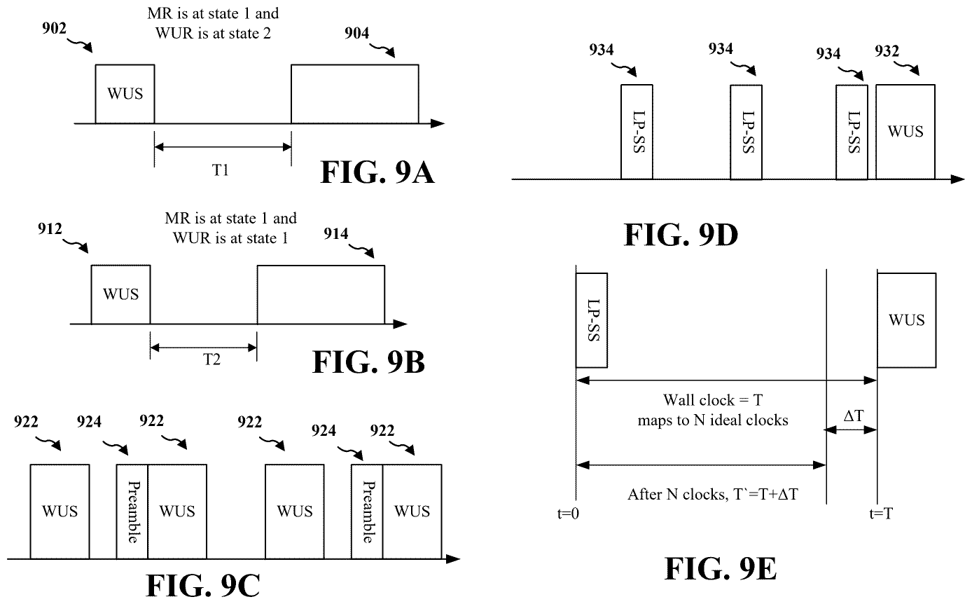

FIGS. 9A and 9B are diagrams illustrating different transition times from receiving the LP-WUS using WUR to the time the MR wakes up or to the time when the MR is ready for PDCCH monitoring. In one example, as shown in FIG. 9A, the MR may be at a state 1 and the WUR may be at a state 2, and the transition time between the UE receiving a WUS, at 902, and the UE waking up, at 904, may be a time T1. In another example, as shown in FIG. 9B, both the MR and the WUR may be at the state 1, and the transition time between the UE receiving a WUS, at 912, and UE waking up, at 914, may be a time T2, and the time T2 may be different from the time T1.

The gap for each sleep state at the MR and the WUR may be specific to a frequency band, a combination of frequency bands, a BWP, a combination of BWPs, a component carrier (CC), or a combination of CCs. Different sleeping modes may be defined, or configured, for a specific band, BWP, a CC, or a combination thereof. There may be different sleeping modes (or power modes) or sleeping states (or power states) (for MR only or for both MR and WUR) per band, per BWP, or per CC, or a combination thereof. Each CC, band, BWP, or a combination thereof may be associated with different power states, e.g., of the MR and/or WUR. The sequence of sleep modes may be a function of a CC and/or BWP used by the MR and/or a band or frequency configuration used by the WUR.

A WUS signal can be preceded by a preamble signal/sequence for synchronization. The preamble signal/sequence may improve the detectability of the WUS. The preamble signal/sequence may have its own configuration, including periodicity, that is different from the configuration of the WUS signal. FIG. 9C is a diagram illustrating preamble signals and WUS in wireless communication. As shown in FIG. 9C, a WUS 922 is preceded by a preamble signal/sequence 924. The preamble signal/sequence 924 may have a different periodicity than that of the WUS 922. For example, as shown in FIG. 9C, the WUS 922 is transmitted at twice the frequency of the preamble signal/sequence 924.

In some aspects, a base station may always configure each WUS with a preamble sequence that is used by the receiver for synchronization. However, this might be costly, due to increased overhead from the base station. In some examples, the base station may configure UEs with periodic synchronization signals with more time sparse pattern, depending on a clock drift. The periodic synchronization signals may be used by all UEs or a group of UEs having the same clock characteristics. The UE may rely on the LP-SS to reset the clock. Then the UE may adjust the timing to receive the WUS signals. The LP-SS can be transmitted as a pre-set periodicity, like the SSB signals. FIG. 9D is a diagram illustrating LP-SS and WUS in wireless communication. As shown in FIG. 9D, an LP-SS 934 may be transmitted at a pre-set periodicity, and The UE may rely on the LP-SS to reset the clock and to adjust the timing to receive the WUS signals 932.

Once the UE receives an LP-SS, it will reset the clock, then it starts to drift. FIG. 9E is a diagram illustrating the clock frequency drift in wireless communication. Depending on the SNR, the UE can be able to quickly determine the LP-SS or will have to monitor multiple LP-SS. Assuming clock frequency drift is F′, at time T from t=0, the WUR timing will be T+ΔT, as shown in FIG. 9E, where ΔT=±0.5*F′ *T² during the non-linear transition time. Once T≥Fₑ/F′, where Fₑ is the maximum clock error (e.g., 5 ppm), ΔT=±FₑT. As shown from these expressions, once the UE resets the clock, the drift is smaller since F′ is in an order of 0.0x while Fₑ is in an order of x. The performance may be further improved with the availability of both LP-SS and preamble signal. For example, an LP-SS may fix the timing, and a preamble signal may further reduce or remove part of the timing error.

In addition, the LP-SS may reduce the complexity of search for the preamble and WUS signal. Without such signal, the ΔT is large, which means the WUR has to keep searching for a longer duration due to increased uncertainty. Consider the case of sleeping for 40 min, without any LP-SS, the WUR may have to search at least one periodicity of WUS occasions and start to process those samples. In some cases, it will continuously search for LP-WUS until it finds the WUS, which will consume considerable amount of energy by the WUR.

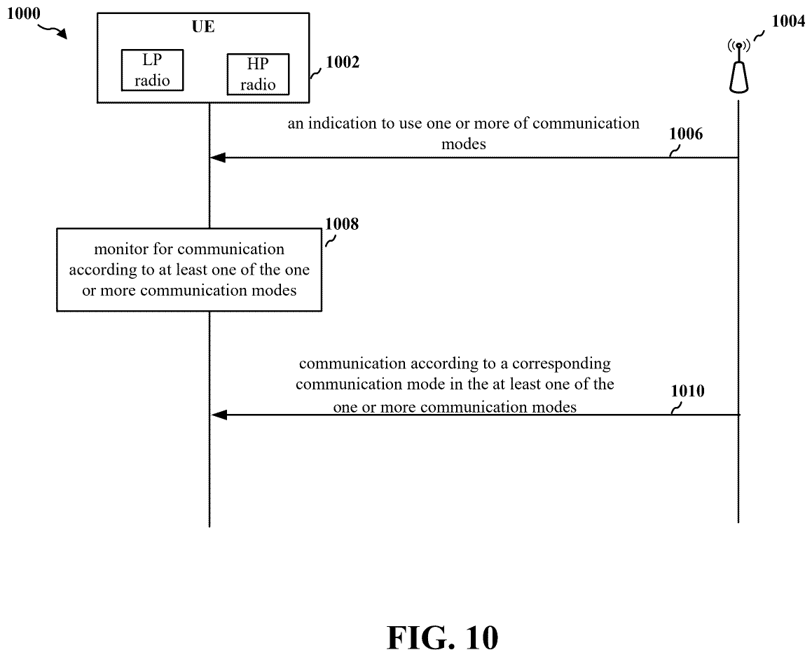

FIG. 10 is a call flow diagram 1000 illustrating a method of wireless communication in accordance with various aspects of this present disclosure. Although aspects are described for a base station 1004, the aspects may be performed by a base station in aggregation and/or by one or more components of a base station 1004 (e.g., such as a CU 110, a DU 130, and/or an RU 140). As shown in FIG. 10, a UE 1002 (e.g., having a lower power radio (e.g., LP radio, which may be referred to herein as a WUR) and a higher power radio (e.g., HP radio which may be referred to herein as a MR)) may receive, at 1006, an indication to use one or more of communication modes. As an example, the base station 1004 may configure the one or more communication modes in RRC signaling to the UE 1002. In some aspects, the base station 1004 may indicate the one or more communications modes in a MAC-CE or other control signaling to the UE 1002. In some aspects, the base station 1004 may activate a previously configured (e.g., RRC configured) one or more communication modes in a MAC-CE. In some aspects, the base station 1004 may indicate one or more communication modes in a MAC-CE of previously configured communication modes (e.g., the individual modes configured in RRC signaling). Each of the communication modes may be associated with a configuration of at least one of a first radio and a second radio. The second radio may have a lower power consumption than the first radio. In one example, the first radio may be the HP radio of the UE 1002, and the second radio may be the LP radio of the UE 1002.

At 1008, the UE 1002 may monitor for communication according to at least one of the one or more communication modes from the base station 1004. For example, at 1008, the UE 1002 may switch between different communication modes in a pattern or sequence as indicated by the base station 1004 and/or the UE 1002. At 1010, the base station 1004 may transmit communication to the UE 1002 according to a corresponding communication mode in the one or more communication modes at a time the communication is transmitted to the UE 1002.

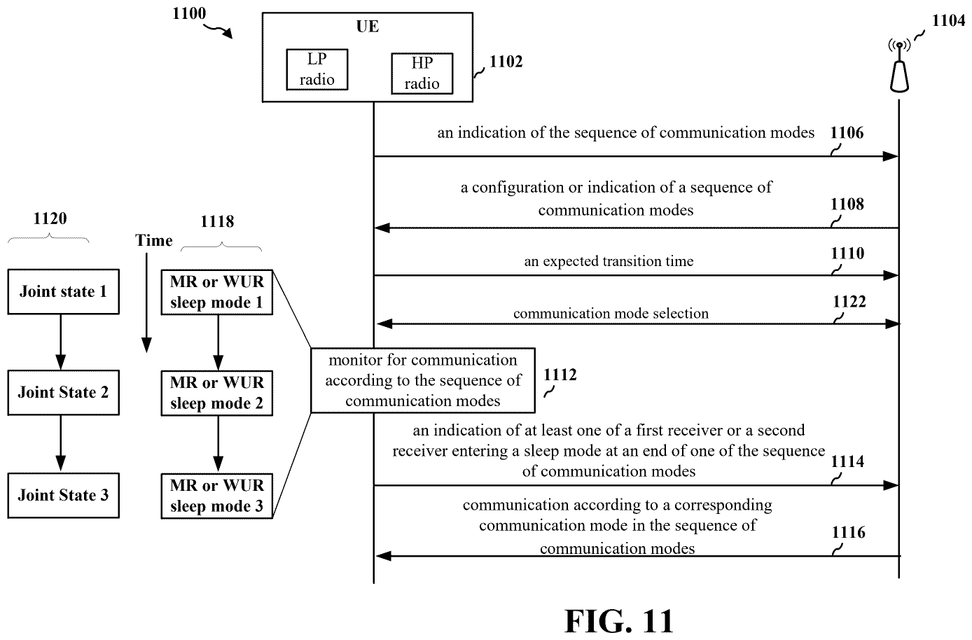

FIG. 11 is an example call flow diagram 1100 illustrating a method of wireless communication in accordance with various aspects of the present disclosure. Although aspects are described for a base station 1104, the aspects may be performed by a base station in aggregation and/or by one or more components of a base station 1104 (e.g., such as a CU 110, a DU 130, and/or an RU 140). As shown in FIG. 11, a UE 1102 (e.g., having a lower power radio (e.g., LP radio) and a higher power radio (e.g., HP radio)) may receive a configuration, or other indication, for a sequence of communication modes for the UE. For example, the base station 1104 may transmit, at 1108, a configuration including a sequence of communication modes to the UE 1102. As an example, the base station 1104 may configure the sequence of communication modes in RRC signaling to the UE 1102. In some aspects, the base station 1104 may indicate the sequence of communications modes in a MAC-CE or other control signaling to the UE 1102. In some aspects, the base station 1104 may activate a previously configured (e.g., RRC configured) sequence of communication modes in a MAC-CE. In some aspects, the base station 1104 may indicate a sequence in a MAC-CE of previously configured communication modes (e.g., the individual modes configured in RRC signaling). Each of the communication modes may be associated with a time interval and may be associated with a different power state for the UE 1102.

In some aspects, as shown at 1106, the UE 1102 may transmit an indication of the sequence of communication modes to a base station 1104 before receiving the indication, at 1108, from the base station 1104. The UE 1102 may indicate a preference or suggested sequence of communication modes. The UE 1102 may provide the information in an initial access message, an RRC message (e.g., such as user assistance information, or a reconfiguration RRC), a MAC-CE, and/or in UCI. The base station 1104 may respond with the suggested sequence, at 1108, or may configure a different sequence. In other aspects, the UE 1102 may indicate a sequence of communication modes at 1106, and the base station 1104 may then communicate with the UE 1102 based on the indicated sequence, e.g., without a choice to use/configure a different sequence. At 1110, the UE 1102 may indicate an expected transition time. The expected transition time may be one of: a time between adjacent communication modes of the sequence of communication modes, or a time between a receiving time the second radio receiving an LP-WUS and a wakeup time when the first radio wakes up or is able to monitor PDCCH monitoring occasions. During the transition time between adjacent communication modes of the sequence of communication modes, the UE is not expected to receive or transmit by any of the two radios. During the transition time between a receiving time the second radio receiving an LP-WUS and a wakeup time when the first radio wakes up or is able to monitor PDCCH monitoring occasions, a default behavior for each radio could be defined. In one example, during the transition time between the receiving time and the wakeup time, the WUR may be monitoring, and the MR may be assumed to be not monitoring PDCCH or receiving or transmitting data. In another example, the MR may be monitoring during the transition time between the receiving time and the wakeup time.

At 1112, the UE 1102 may monitor for communication according to the sequence of the communication modes from the base station 1104. For example, at 1112, the UE 1102 may switch between different communication modes in a pattern or sequence as indicated by the base station 1104 and/or the UE 1102. FIG. 11 illustrates an example of a sequence 1118 in which the MR and/or the WUR may be in a first sleep mode for a first interval of time, followed by the MR and/or the WUR being in a second sleep mode for a second interval of time, and the MR and/or the WUR being in a third sleep mode for a third period of time. A second sequence 1120 of communication modes is shown that involves a first joint state for a first time interval, a second joint state for a second time interval, and a third joint state for a third time interval. This is merely one example, and the UE 1102 may monitor according to a sequence of communication modes based on any of the aspects described in connection with 12A-13C.

At 1114, the UE 1102 may transmit an indication of at least one of a first radio or a second radio entering a sleep mode at an end of one of the sequence of communication modes. At 1116, the base station 1104 may transmit communication to the UE 1102 according to a corresponding communication mode in the sequence of communication modes at a time the communication is transmitted to the UE 1102.

In some aspects, at 1122, the UE 1102 may perform a communication mode selection process with the base station 1104. The UE 1102 may perform the communication mode selection process with the base station 1104 through one or more of: an L1 signaling, an L2 signaling, an L3 signaling, or an indication piggybacked on or multiplexed with at least one of UAI, CSI, a PHR, an SR, a RACH message, or HARQ-ACK. In one configuration, the L1 signaling may be through dedicated PUCCH resources or dedicated PUSCH resource, the L2 signaling can through MAC-CE, and the L3 signaling may be through RRC.

The communication mode selection process may include one or more of: the UE 1102 transmitting, to the base station 1104, a desired communication mode at a designated time, during a designated time duration, or until a new communication mode is indicated by the UE 1102; the base station 1104 indicating, to the UE 1102, an indication of a designated communication mode, wherein the UE is configured to communicate according to the designated communication mode until another communication mode is indicated; the UE 1102 transmitting, to the base station 1104, a desired sequence of communication modes; the base station 1104 indicating, to the UE 1102, an indication of a designated sequence of communication modes from multiple sequences of communication modes; the UE 1102 transmitting, to the base station 1104, a desired operating state of one or more of the SW component, the FW component, the HW component, or the RF component of the UE, wherein the desired operating state is one of an ON state or an OFF state; the base station 1104 indicating, to the UE 1102, an indication of a designated operating state for one or more of the SW component, the FW component, the HW component, or the RF component of the UE, wherein the designated operating state is one of an ON state or an OFF state; the UE 1102 transmitting, to the base station 1104, a desired bandwidth for monitoring for at least one of an LP-WUS, an LP-RS, an LP-SS or an LP-sync-preamble signal, or for operating within a BWP for one of the first radio and the second radio within a corresponding time interval; and the base station 1104 indicating, to the UE 1102, a designated bandwidth for monitoring for at least one of an LP-WUS, an LP-RS, an LP-SS or an LP-sync-preamble signal, or for operating within a BWP for one of the first radio and the second radio within a corresponding time interval. Additionally, the communication mode selection process may further include the UE 1102 transmitting to the base station 1104 a desired selection for any of operating/communication modes described above, and the base station 1104 indicating to the UE 1102 a designated selection for the corresponding operating/communication mode.

As illustrated in FIG. 11, according to various aspects of the present disclosure, the UE may be configured with a semi-state or less dynamic pattern/sequence of power states or communication modes for each radio (e.g., the wake-up radio (WUR) or the main radio (MR)). The configuration may be configured/updated through RRC (L3) or MAC-CE (L2), or may be selected from multiple configurations of patterns using L2/L3 communication. The configuration may also be updated or selected through layer 1 (L1) communication. The base station may configure the pattern/sequence of power modes or communication modes based on the indication of the sequence of communication modes from the UE. The UE may also respond to the base station's proposed pattern/sequence with the exact expected transitioning time between the second radio receiving an LP-WUS and a time when the first radio wakes up or is able to monitor PDCCH monitoring occasions. The UE may configure the pattern/sequence and the base station has to respect the UE's configuration. The UE may report its configuration in an initial access message (msg1 or msg 3), RRC (user-assistance information, or reconfigure RRC)/MAC-CE or UCI. The pattern/sequence of power modes or communication modes may be configured, or applied, on a per BWP or per component carrier (CC) basis or a combination thereof. As an example, the first sequence (e.g., 1118) in FIG. 11 may be configured for a first BWP or a first CC, and the second sequence 1120 may be configured for a second BWP or a second CC. In some aspects, UEs with a WUR may not be expected to be configured with multiple BWPs or CCs. In other aspects, a UE with a WUR may be configured with multiple BWPs or CCs may also include a WUR.

A UE may be configured with different configurations across time for operations with MR only, WUR only, or a combination of MR and WUR. The configuration may be associated with a communication mode, a sleep mode, or a power-saving mode of the UE. For example, the configuration may be associated with the power states of Table 2 and Table 3, or the sleep type of Table 4. For example, the configuration may include one of more of: a first density or a first periodicity for monitoring for a PDCCH with a corresponding radio at the UE; a second density or a second periodicity for one or more of: a CSI-RS, a tracking reference signal (TRS), a phase tracking reference signal (PTRS), a sounding reference signal (SRS) for reception at a first main radio; a third density or a third periodicity for monitoring for an LP-RS or an LP-SS with a second radio; a fourth density or a fourth periodicity of reporting CSI, hybrid automatic repeat request acknowledgement (HARQ-ACK), a buffer status report (BSR), or requesting an SR; a bandwidth or a subcarrier spacing (SCS) for monitoring for at least one of an LP-WUS, an LP-RS, or an LP-SS, or for operating within a BWP for the main radio within a corresponding time interval; and a measurement configuration for radio resource management (RRM) for one or more of a serving cell or a non-serving cell, or a combination thereof.

The LP-WUS may be a signal that is similar to an NR WUS, which is a PDCCH-based DCI with polar coding, which is a coded control signal such as DCI. The LP-WUS may also be a sequence-based signal including, but not limited to, DFT, Gold, ASK PSK, PPM, PWM, PAM, Walsh, m-sequence, Zadoff, Reed Solomon signal. The LP-WUS may also be an OOK-based waveform signal. The waveform may be OFDM, modulating the time domain signal with low and high voltage signals.

The LP-RS may be a sequence-based signal including, but not limited to, DFT, Gold, ASK, PSK, PPM, PWM, PAM, Walsh, m-sequence, Zadoff, Reed Solomon signal. The LP-RS may also be an OOK-based waveform signal. The waveform may be OFDM, DFT-s-OFDM, signal carrier, or SC-QAM, modulating the time domain signal with different voltages.

The LP-SS may be a sequence-based signal similar to SSB's PSS or SSB's SSS. The LP-SS may also be a time domain sequence-based signal which is modulating the time domain signal with a sequence. The LP-SS may also be an OOK-based waveform signal. The waveform may be OFDM, modulating the time domain signal with low and high voltage signals.

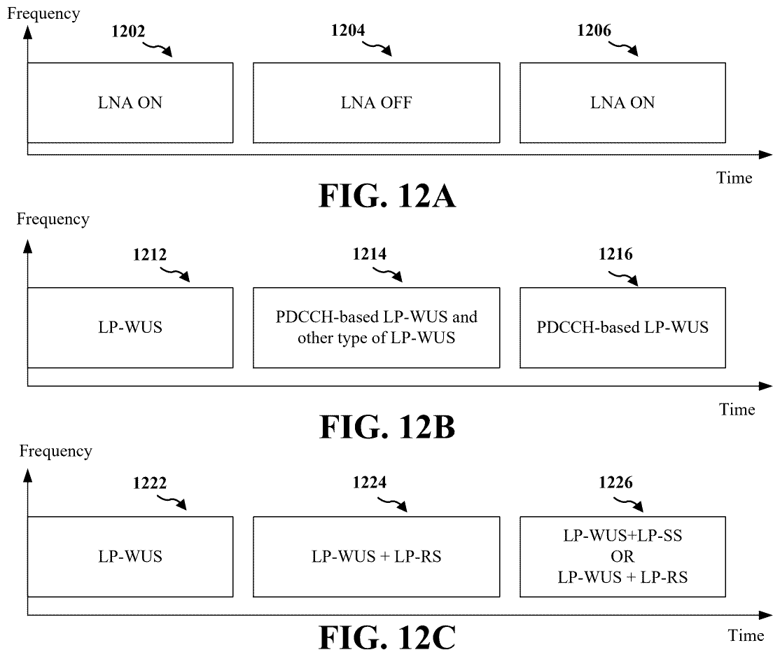

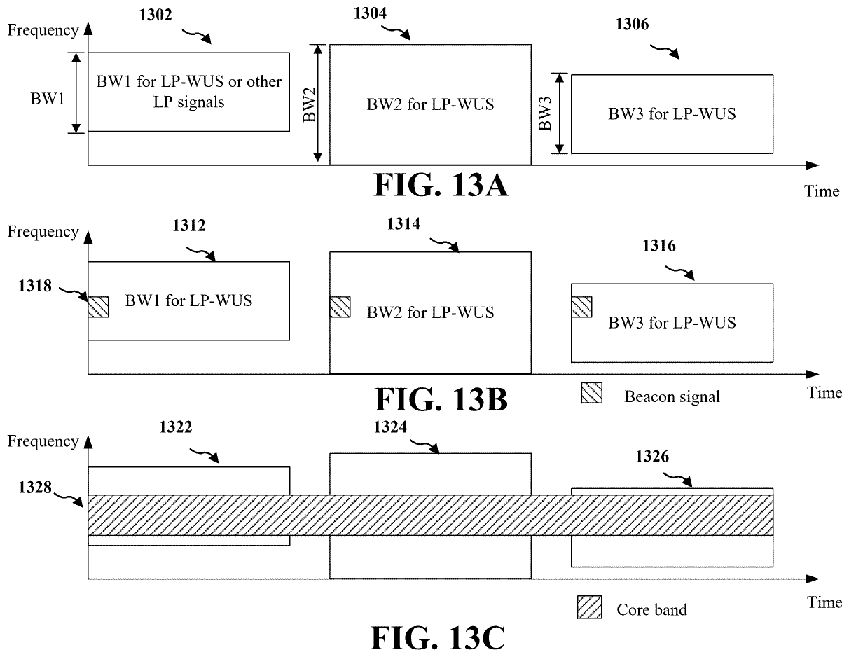

FIGS. 12A, 12B, 12C, 13A, 13B, and 13C are diagrams illustrating various example aspects of sequences of the communication modes in accordance with various aspects of the present disclosure.

In some aspects, the indication of a sequence (from the base station to the UE or from the UE informing the base station) may indicate that one or more components of the UE are to be in an ON state or an OFF state according to the sequence. The components may include one or more of: the software (SW) component, the firmware (FW) component, the hardware (HW) component, or the radio frequency (RF) component.

For example, referring to FIG. 12A, the sequence of communication modes 1202, 1204, 1206 may be related to an LNA in the UE. The sequence of communication modes may include a communication mode 1202, in which the LNA is set at an ON state (LNA ON), a communication mode 1204, in which the LNA is set at an OFF state (LNA OFF), and a communication mode 1206, in which the LNA is set at an ON state (LNA ON). In the example shown in FIG. 12A, the WUR may move to a corresponding LNA ON state at communication modes 1202 and 1206, and move to a corresponding LNA OFF state at communication mode 1204. If the LNA status is not part of the power consumption mode of the UE, the sequence of communication mode would be an indication of using (for 1202 and 1206) or not using (for 1204) the LNA. There could be time gaps, transition periods, or offsets to accommodate for time to turn ON or OFF the LNA, which could be the transition time for the LNA from the ON state to the OFF state, or from the OFF state to the ON state. The sequence of communication modes is applicable to other RF components, such as a power amplifier (PA) for transmission in the UE, if the WUR has a Tx component.

In some aspects, the indicated sequence (from the base station to the UE or from the UE informing the base station) may be changing from monitoring LP-WUS to monitoring PDCCH-based WUS, and the monitoring of the PDCCH-based WUS may be performed by the MR or the WUR. For example, referring to FIG. 12B, the sequence of communication modes 1212, 1214, 1216 may be related to monitoring LP-WUS at communication mode 1212, monitoring PDCCH-based LP-WUS and other types of LP-WUS at communication mode 1214, and monitoring PDCCH-based LP-WUS at communication mode 1216. The size of each period (e.g., 1212, 1214, 1216) may be different, and the pattern may indicate a plurality of times and which type of PDCCH is expected in the plurality of times.

In some aspects, the indicated sequence (from the base station to the UE or from the UE informing the base station) may relate to monitoring one or more of an LP-RS, an LP-SS, an LP-WUS, or other signals or skipping monitoring such signals. For example, referring to FIG. 12C, the sequence of communication modes 1222, 1224, 1226 may be related to monitoring LP-WUS at communication mode 1222, monitoring a combination of LP-WUS and LP-RS at communication mode 1224, and monitoring either a combination of LP-WUS and LP-SS or a combination of LP-WUS and LP-RS at communication mode 1226. The size of each period (e.g., 1222, 1224, 1226) may be different, and the pattern may indicate a plurality of times and which type of signal to monitor in the plurality of times.

In some aspects, the indicated sequence (from the base station to the UE or from the UE informing the base station) may be related to using different bandwidths for WUR to monitor a WUR or a reference signal (RS). For example, referring to FIG. 13A, the sequence of communication modes 1302, 1304, 1306 may be related to monitoring LP-WUS or other LP signals using bandwidth 1 (BW1) at communication mode 1302, monitoring an LP-WUS using bandwidth 2 (BW2) at communication mode 1304, and monitoring an LP-WUS using bandwidth 3 (BW3) at communication mode 1306. The size of each period (e.g., 1302, 1304, 1306) may be different, and the pattern may indicate a plurality of times and which type of signal to monitor in the plurality of times.

In some aspects, a beacon signal (or synchronization signal, indication signal, control signal) may be added at the beginning of each of communication modes to active the corresponding communication mode or to change the communication mode. To facilitate the WUR to monitor the corresponding signals, the monitoring occasion corresponding to the beacon signals in the communication modes may be aligned on the frequency domain and in the time domain. That is, the beacon signals in the communication modes may occupy the same, or overlapping, frequency band and the same, or related, time interval/position relative to the corresponding interval for the respective communication modes. For example, referring to FIG. 13B, each communication mode in the sequence of communication modes (e.g., 1312, 1314, 1316) may have a beacon signal 1318. The beacon signals 1318 at each of the communication modes in the sequence of communication modes (e.g., 1312, 1314, 1316) may occupy the same frequency band and the same time interval relative to the corresponding communication modes.

In some aspects, the frequency bandwidths for the communication modes may have a shared core frequency band. For example, referring to FIG. 13C, the frequency bands specified by the communication modes (e.g., 1322, 1324, 1326) may have a shared, or common, core frequency band (the core band 1328).

In some aspects, the indicated sequence (from the base station to the UE or from the UE informing the base station) may be related to using different bandwidths (BW) for the MR within the same BWP. The configuration may change across different communication modes in the sequence of communication modes. In one configuration, different communication modes may have different BW for the MR. The size of each communication mode may be different, and the pattern may indicate a plurality of times and which type of signal to monitor in the plurality of times. A core bandwidth (e.g., a common frequency band all the communication modes may share) may be defined for the MR too.

In some aspects, a UE may indicate that it will enter a particular sleep mode or communication mode for one or more radios (or a joint state for multiple radios) in the UE at the end of each DRX active time. This indication may be sent standalone, piggybacked on HARQ-ACK, RRC, SR, BSR, PHR, or any report or PUCCH/PUSCH occasion, or using RRC or user assistance information.

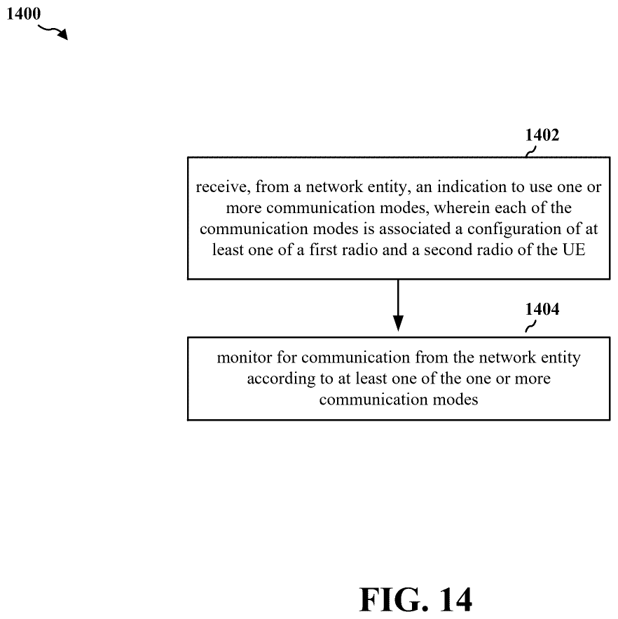

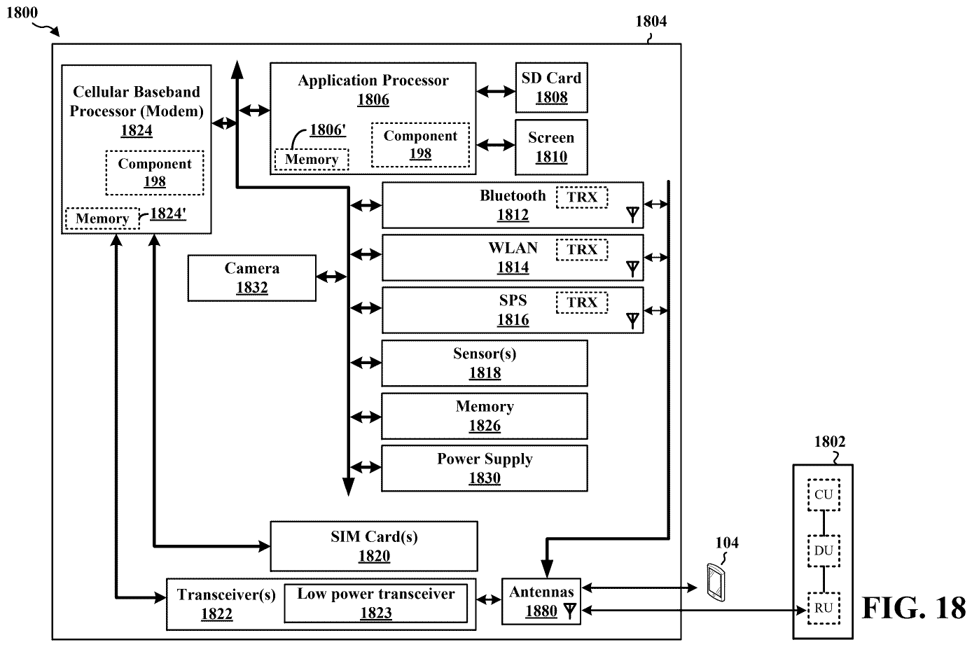

FIG. 14 is a flowchart 1400 illustrating methods of wireless communication at a UE in accordance with various aspects of the present disclosure. The method may be performed by a UE. The UE may be the UE 104, 350, 504, 514, 1002, 1102, or the apparatus 1804 in the hardware implementation of FIG. 18. The UE may have a first radio and a second radio. The second radio may have a lower power consumption than the first radio. The method enables the sequential indication of communication modes (or power saving states, sleeping states, data traffic modes, or modes) related to the WUS for a UE to operate in a more semi-static manner with known patterns of configuration changes. In addition, the method includes the indication of operating certain components, such as an LNA in a WUR, or certain bandwidths for the UE, and the indication may include a core bandwidth or frequency range for the WUR. The method improves the power efficiency of wireless communication.

As shown in FIG. 14, at 1402, the UE may receive an indication to use one or more communication modes from a network entity. Each of the communication modes may be associated with a configuration of at least one of the first radio and the second radio of the UE. The network entity may be a base station, or a component of a base station, in the access network of FIG. 1 or a core network component (e.g., base station 102, 310; base station 1004, 1104; or the network entity 1802 in the hardware implementation of FIG. 18). For example, the one or more communication modes may be related to the power states of Table 2 and Table 3, or the sleep type of Table 4. FIGS. 10, 11, 12A, 12B, 12C, 13A, 13B, and 13C illustrate various aspects of the steps in connection with flowchart 1400. For example, referring to FIG. 10, the UE 1002 may receive, at 1006, an indication to use one or more communication modes from a network entity (base station 1004). For example, the one or more communication modes may be the sequence of communication modes shown in one of FIGS. 12A, 12B, 12C, 13A, 13B, and 13C. That is, the one or more communication modes may be one of the sequences of communication modes 1202 through 1206, 1212 through 1216, 1222 through 1226, 1302 through 1306, 1312 through 1316, or 1322 through 1326.

At 1404, the UE may monitor for communication from the network entity according to at least one of the one or more communication modes. For example, referring to FIG. 10, the UE 1002 may, at 1008, monitor for communication according to at least one of the one or more communication modes.

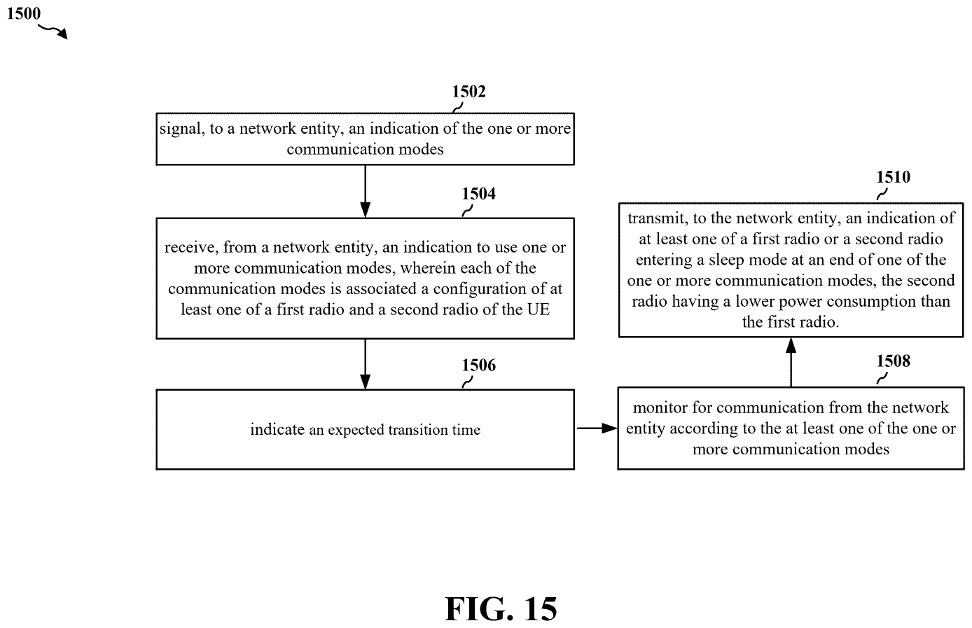

FIG. 15 is a flowchart 1500 illustrating methods of wireless communication at a UE in accordance with various aspects of the present disclosure. The method may be performed by a UE. The UE may be the UE 104, 350, 504, 514, 1002, 1102, or the apparatus 1804 in the hardware implementation of FIG. 18. The UE may have a first radio and a second radio. The second radio may have a lower power consumption than the first radio. The method enables the sequential indication of communication modes (or power saving states, sleeping states, data traffic modes, or modes) related to the WUS for a UE to operate in a more semi-static manner with known patterns of configuration changes. In addition, the method includes the indication of operating certain components, such as an LNA in a WUR, or certain bandwidths for the UE, and the indication may include a core bandwidth or frequency range for the WUR. The method improves the power efficiency of wireless communication.

As shown in FIG. 15, at 1504, the UE may receive an indication to use one or more communication modes from a network entity. Each of the communication modes may be associated with a configuration of at least one of the first radio and the second radio of the UE. The network entity may be a base station, or a component of a base station, in the access network of FIG. 1 or a core network component (e.g., base station 102, 310; base station 1004, 1104; or the network entity 1802 in the hardware implementation of FIG. 18). For example, the one or more communication modes may be related to the power states of Table 2 and Table 3, or the sleep type of Table 4. FIGS. 10, 11, 12A, 12B, 12C, 13A, 13B, and 13C illustrate various aspects of the steps in connection with flowchart 1500. For example, referring to FIG. 10, the UE 1002 may receive, at 1006, an indication to use one or more communication modes from a network entity (base station 1004). For example, the one or more communication modes may be the sequence of communication modes shown in one of FIGS. 12A, 12B, 12C, 13A, 13B, and 13C. That is, the one or more communication modes may be one of the sequences of communication modes 1202 through 1206, 1212 through 1216, 1222 through 1226, 1302 through 1306, 1312 through 1316, or 1322 through 1326.

At 1508, the UE may monitor for communication from the network entity according to at least one of the one or more communication modes. For example, referring to FIG. 10, the UE 1002 may, at 1008, monitor for communication according to at least one of the one or more communication modes.

In some aspects, the configuration of at least one of the first radio and the second radio may be associated with at least one of: a sleep mode for at least one of the first radio or the second radio of the UE; a power mode for at least one of the first radio or the second radio of the UE; one or more predicted data arrival traffic for at least one of data transmission or data reception by the UE; at least one of priority, QoS, and latency of the one or more predicted data arrival traffic for at least one of data transmission or data reception by the UE; or coverage and communications sensitivity requirements of the network entity. For example, referring to FIGS. 5A, 5B, and 10, when the UE 1002 receives, at 1006, an indication to use one or more of communication modes each associated with a configuration of at least one of the first radio (e.g., the HP radio) and the second radio (e.g., the LP radio), the configuration of at least one of the first radio (e.g., HP radio) and the second radio (e.g., the LP radio) may be associated with at least one of: a sleep mode for at least one of the first radio (e.g., HP radio) or the second radio (e.g., the LP radio) of the UE 1002; a power mode for at least one of the first radio (e.g., HP radio) or the second radio (e.g., the LP radio) of the UE 1002; one or more predicted data arrival traffic for at least one of data transmission or data reception by the UE 1002; at least one of priority, QoS, and latency of the one or more predicted data arrival traffic for at least one of data transmission or data reception by the UE 1002; and coverage and communications sensitivity requirements of the network entity (base station 1004). The power mode may be one of the power states of Table 2 and Table 3, and the sleep mode may be one of the sleep types of Table 4.

In some aspects, the configuration for each of the one or more communication modes may include, but not be limited to, one or more of: one or more of an active or inactive software (SW) component, an active or inactive firmware (FW) component, an active or inactive hardware (HW) component, or an active or inactive radio frequency (RF) component to be used by at least one of the first radio or the second radio of the UE; one or more of discontinuous reception (DRX) configurations to be used by at least one of the first radio or the second radio based on an RRC state; one or more of first components in the UE to be used for processing complex signals using the first radio or the second radio; one or more of second components in the UE to be used for processing polar decoding using the first radio or the second radio; a capability to process a signal in at least one of a time domain or a frequency domain using the first radio or the second radio; a time for one or more of: performing decoding or detection of the WUS or one or more of LP-RS, LP-SS, LP-sync-preamble signal processing using the first radio or the second radio; PDCCH monitoring occasions on at least one search space group associated with the first radio or the second radio of the UE; a time and frequency configuration for the communication of the UE associated with one of the first radio or the second radio; a periodicity configuration for the communication of the UE associated with one of the first radio or the second radio; a bandwidth configuration for the communication of the UE using the first radio or the second radio; and a subcarrier spacing (SCS) configuration for the communication of the UE using the first radio or the second radio.

In some aspects, the configuration for each of the one or more communication modes may further include one or more of: a measurement configuration for radio resource management (RRM) for one or more of a serving cell or nearby cells of the UE using the first radio or the second radio; a measurement configuration for a relaxation of RRM for one or more of a serving cell or nearby cells or for at least one type of an intra-frequency type or an inter-frequency type of the UE using the first radio or the second radio; a measurement configuration for allowing an RRM measurement offloading for at least one of serving cell RRM measurements or nearby cells RRM measurements and for at least an RRM measurement type of the inter-frequency type or the intra-frequency type from the first radio to the second radio or from the second radio to the first radio; and a monitoring configuration for monitoring for one or more of a synchronization signal block (SSB), a system information change, or a system information block (SIB) signal using the first radio or the second radio. For example, referring to FIG. 10, when the UE 1002 receives, at 1006, an indication to use one or more of communication modes from the network entity (base station 1004), the configuration for each of the one or more communication modes may further include one or more of the configurations listed above.

In some aspects, each of the one or more communication modes may be associated with the configuration of at least one of the first radio and the second radio during one of: an RRC connected state, an RRC idle state, or an RRC inactive state. The one or more communication modes further include one or more of: a first DRX configuration for monitoring a WUR by the second radio; a second DRX configuration for monitoring a paging occasion by the second radio during the RRC inactive state; and a third DRX configuration for paging monitoring by the second radio during the RRC idle state. For example, referring to FIG. 10, when the UE 1002 receives, at 1006, an indication to use one or more of communication modes from the network entity (base station 1004), each of the one or more communication modes may be associated with the configuration of at least one of the first radio (e.g., HP radio) and the second radio (e.g., LP radio) during one of: an RRC connected state, an RRC idle state, or an RRC inactive state. The one or more communication modes may further include one or more of: a first DRX configuration for monitoring a WUR by the second radio (e.g., LP radio); a second DRX configuration for monitoring a paging occasion by the second radio (e.g., LP radio) during the RRC inactive state; and a third DRX configuration for paging monitoring by the second radio (e.g., LP radio) during the RRC idle state.

In some aspects, multiple DRX configurations may be allowed for each RRC state (e.g., the RRC connected state, the RRC idle state, or the RRC inactive state), and a specific DRX configuration for an RRC state may be set or reconfigured through one or more of the L1 signaling, the L2 signaling, and the L3 signaling. In some examples, the L1 (or L2, or L3) signaling for setting or reconfiguring a specific DRX configuration for an RRC state may be associated with the one or more communication modes.

In some aspects, each of the one or more communication modes may correspond to at least one of a BWP and a CC, and the one or more communication modes may be received through one of the RRC or medium access control-control element (MAC-CE). For example, referring to FIG. 10, when the UE 1002 receives, at 1006, an indication to use one or more of communication modes from the network entity (base station 1004), each of the one or more communication modes may correspond to at least one of a BWP and a CC, and the one or more communication modes may be received, at 1006, through one of the RRC or the MAC-CE.

In some aspects, the indication received from the network entity may include a sequence of communication modes, and each of the communication modes may be associated with a time interval. When monitoring for communication from the network entity using the first radio or the second radio, the UE may monitor, according to the sequence of communication modes, for communication from the network entity using the first radio or the second radio. For example, the sequence of communication modes may be related to the power states of Table 2 and Table 3, or the sleep type of Table 4. For example, referring to FIG. 11, the UE 1102 may receive, at 1108, a configuration including a sequence of communication modes from a network entity (base station 1104). For example, the sequence of communication modes may be the sequence of communication modes shown in one of FIGS. 12A, 12B, 12C, 13A, 13B, and 13C. That is, the sequence of communication modes may be one of the sequences of communication modes 1202 through 1206, 1212 through 1216, 1222 through 1226, 1302 through 1306, 1312 through 1316, or 1322 through 1326. For example, referring to FIG. 11, the UE 1102 may, at 1112, monitor for communication according to the sequence of communication modes.

In some aspects, each communication mode in the sequence of communication modes may be associated with the first radio or the second radio. The UE may monitor for the communication from the network entity using the first radio or the second radio according to the sequence of communication modes configured by the network entity. For example, referring to FIG. 5A, the first radio may be the high-power radio component 506 of the UE 504, and the second radio may be the low-power radio component 508 of the UE 504. And the UE 504 may monitor for the communication from the network entity using the first radio (high-power radio component(s) 506) or the second radio (low-power radio component(s) 508) according to the sequence of communication modes configured by the network entity.

In some aspects, the sequence of communication modes may correspond to at least one of a BWP and a CC, and the configuration may be received through one of the RRC or the MAC-CE. For example, referring to FIG. 11, the sequence of communication modes transmitted by the base station 1104 at 1108 may correspond to at least one of a BWP and a CC, and the configuration the UE 1102 receives at 1108 may be received through one of the RRC or the MAC-CE.

At 1502, the UE may signal an indication of the sequence of communication modes, prior to receiving the configuration to a network entity. For example, referring to FIG. 11, the UE 1102 may, at 1106, signal to the network entity (base station 1104) an indication of the sequence of communication modes, prior to receiving the configuration from the network entity (base station 1104) at 1108. The base station 1104 may transmit, at 1108, the configuration including the sequence of communication modes based on the indication received, at 1106, from the UE 1102.

At 1506, the UE may indicate an expected transition time. The expected transition time may be one of: a time between adjacent communication modes of the sequence of communication modes, or a time between a receiving time the second radio receiving an LP-WUS and a wakeup time when the first radio wakes up or is able to monitor PDCCH monitoring occasions. For example, referring to FIG. 11, the UE 1102 may indicate, at 1110, an expected transition time. The expected transition time may be one of: a time between adjacent communication modes of the sequence of communication modes, or a time between the second radio receiving an LP-WUS and a wakeup time when the first radio wakes up or is able to monitor PDCCH monitoring occasions.

In some aspects, the time and frequency configuration may include one or more: a first configuration for monitoring for a physical downlink control channel (PDCCH) with a corresponding radio at the UE; a second configuration for monitoring one or more of: a channel state information reference signal (CSI-RS), a tracking reference signal (TRS), a phase tracking reference signal (PTRS), a sounding reference signal (SRS) for reception at the first radio; a third configuration including a WUS configuration and a preamble signal configuration. The WUS configuration may be for monitoring at least one of a low power wakeup signal (LP-WUS), a low power reference signal (LP-RS), or a low power synchronization signal (LP-SS). The preamble signal configuration may be for monitoring a low power synchronization preamble (LP-sync-preamble) signal associated with the LP-WUS with the second radio. The LP-sync-preamble signal may be a part of the LP-WUS configuration. The configuration for an LP-sync-preamble signal, such as its bandwidth, duration, periodicity, may be the same as or different from the configuration of the LP-WUS signal. In some examples, the LP-SS, LP-RS, LP-sync-preamble signal, LP-WUS may be monitored by the same group of UEs. In some other examples, each resource of LP-SS, LP-RS, LP-sync-preamble signal, LP-WUS may be associated with its own group of UEs. The LP-SS may be continuously transmitted signal (e.g., like SSB), while an LP-sync-preamble signal may be transmitted less frequently. In some cases, an LP-sync-preamble signal may be associated with an LP-WUS. In some other cases, an LP-sync-preamble signal maybe associated with a WUS but can be sent in some time WUS is not present.

The time and frequency configuration may further include a fourth configuration of reporting channel state information (CSI), hybrid automatic repeat request acknowledgement (HARQ-ACK), a buffer status report (BSR), or requesting a scheduling request (SR); and a repetition factor for one or more of: the SRS, the CSI-RS, the PTRS, the TRS, the LP-SS, the LP-WUS, the LP-sync-preamble signal, the LP-RS, the HARQ-ACK, and the CSI.

In some aspects, a low power (LP) resource set may be defined. The LP resource set may include an LP-WUS resource and an LP-sync-preamble resource. In some examples, the LP resource set may include multiple resources for LP-WUS and multiple resource for LP-sync-preamble signal. The number of resources for WUS and the number of resources for LP-sync-preamble may be the same or different.

The periodicity configuration may include one or more of: a first periodicity for monitoring for the PDCCH with a corresponding radio at the UE; a second periodicity for monitoring one or more of: the CSI-RS, the TRS, the PTRS, the SRS for the reception at the first radio; a third periodicity for monitoring the LP-RS or the LP-SS with the second radio; and a fourth periodicity of reporting the CSI, the HARQ-ACK, the BSR, or requesting the SR.

In some aspects, a LP resource set may be defined. The LP resource set may include a resource for each of LP-RS, LP-SS, LP-WUS, and LP-sync-preamble signal. Each of these resources may have its own configuration. The LP resource set may include multiple resources for each of LP-RS, LP-SS, LP-WUS, and LP-sync-preamble signal, and each resource may have its configuration defining, for example, the repetition or the periodicity of these signals.

The bandwidth configuration for the communication of the UE may include the bandwidth for monitoring for at least one of an LP-WUS, an LP-RS, or an LP-SS, or for operating within a BWP for the first radio within a corresponding time interval. The SCS configuration for the communication of the UE may include the SCS for monitoring for at least one of the LP-WUS, the LP-RS, or the LP-SS, or for operating within the BWP for the first radio within a corresponding time interval. For example, referring to FIG. 11, when the UE 1102 receives, at 1108, a configuration including a sequence of communication modes from a network entity (base station 1104). One or more communication modes in the sequence of communication modes may include a time and frequency configuration, a periodicity configuration, a bandwidth configuration and an SCS configuration. The time and frequency configuration, the periodicity configuration, the bandwidth configuration, and the SCS configuration may include one or more of the respective configurations described above.

In some aspects, each of the LP-WUS, the LP-RS, and the LP-SS may be one of: a coded control signal, a sequential-based signal, or an OOK-based waveform signal. For example, referring to FIG. 12C, when the sequence of communication modes 1222, 1224, 1226 are related to monitoring LP-WUS, LP-WUS, LP-RS, LP-SS or a combination of these signals at one or more of the communication modes 1222, 1224, 1226, the LP-WUS, the LP-RS and the LP-SS may be one of: a coded control signal, a sequential-based signal, or an OOK-based waveform signal.

In some aspects, the LP-WUS payload, which may be group specific to wake up a group of UEs, may be different from one communication mode to another communication mode, or from one RRC state to another RRC state. Therefore, based on the RRC state or the communication mode, a UE may determine the LP-WUS payload that may be used to wake up). The LP-WUS payload may be a part of the configuration. The same principle may be applicable to the LP-RS and the LP-SS. That is, the payload of an LP-RS (or an LP-SS) may be a part of the configuration and may be determined based on the communication mode or the RRC state.

In some aspects, a Radio Network Temporary Identifier (RNTI) or a scrambling ID for scrambling an LP-WUS may be communication mode or RRC state specific. If an LP-SS or an LP-RS is generated using scrambling IDs, different scrambling IDs may be used for each communication mode and for each RRC state.

In some aspects, each of the communication modes may be related to one or more components at the UE being in an ON state or an OFF state within a corresponding time interval. The components may include one or more of: the SW component, the FW component, the HW component, or the RF component. For example, referring to FIG. 12A, the sequence of communication modes 1202, 1204, 1206 may be related to a radio frequency component (e.g., an LNA) at the UE being in an ON state (at 1202 and 1206) or an OFF state (at 1204).

In some aspects, communication modes in the sequence of communication modes may include different configurations to monitor for one or more of LP-WUS or PDCCH-based WUS within a corresponding time interval. For example, referring to FIG. 12B, communication modes 1212, 1214, 1216 in the sequence of communication modes (1212, 1214, 1216) may include different configurations to monitor for one or more of LP-WUS (at 1212) or PDCCH-based WUS (at 1214, 1216) within a corresponding time interval. Both types are monitored by the LP-WUR.

In one aspect, the MR and the LP-WUR configuration may be based on UE-reported capabilities and suggested communication mode by the UE. During the communication modes where the UE can perform more than one type of WUS monitoring using the LP-WUR, such as (1) PDCCH-based DCI (e.g., a polar coded DCI used in the base station), (2) sequence-based signals (based on, e.g., the DFT, the ZC sequence, the Gold transform, the Hadamard transform), or (3) OOK/amplitude-shift keying (ASK)/frequency shift keying (FSK) based modulated waveforms (e.g., OFDM waveforms), the UE may indicate which type of WUS to be monitored at a time during the communication mode. By default, during a communication mode, the UE is expected to monitor any type of WUS and the base station is expected to transmit the two types. In some examples, the base station may decide, within the communication mode, to transit one type of WUS and the UE may monitor that type of WUS using the WUR. PDCCH-based DCI may be associated with a greater power consumption than sequence-based signals and sequence-based signals may be associated with a greater power consumption than OOK/ASK/FSK based modulated waveforms. PDCCH-based DCI may be associated with a greater/higher sensitivity or network coverage than sequence-based signals and sequence-based signals may be associated with a greater/higher sensitivity or network coverage than OOK/ASK/FSK based modulated waveforms.

During a communication mode/state, the UE may select which type of WUS (and the associated LP signals such as LP-RS, LP-SS, LP-sync-preamble signal) it wants to monitor using the WUR. The base station may determine the type(s) of WUS to monitor based on various factors. These factors may include, but not limited to, current UE's current communication mode, the UE's indication about its desired LP signals or radio to use, the UE's capability to monitor using both radios during the current communication mode, the UE's mobility (based on RRM measurement or SRS transmissions from UE or indication of mobility from UE), the latency requirements (based on UE's downlink traffic and UE's UL traffic assuming it is known at the base station or reported to the base station through UE's regular report), and the sensitivity or coverage requirements and characteristics. The base station may determine the type(s) of WUS to monitor based in part on the expected/predicted traffic for the UE (e.g., eMBB, XR, URLLC, etc) and the L1/L2 priorities and QoS of such traffic (DL or UL or both). The base station's indication during a communication mode may be dynamic and indicated in L1, L2, or L3 signaling from time to time. The indication may also be done using UAI (e.g., an RRC indication).

The decision on selecting a certain LP-WUS type (or the type of LP-WUS and radio if the communication mode is a mode where the MR can monitor PDCCH) within a communication mode where multiple types of LP-WUS are supported by a UE's WUR may be based on one or more selection factors. The selection factors may include, but not limited to, the UE's location relative to a serving cell (e.g., UE is near the cell or far from the cell), the UE's current mobility (which may be measured by the UE and indicated to the base station, or measured by the base station through RRM or SRS), the sensitivity characteristic associated with the base station at a time or a time duration, the predicted traffic of the UE and its priority and QoS, the power state of the UE, the current communication mode. In some communication modes where a UE may use both the MR and the WUR, and the MR is not in the sleep mode (i.e., it can monitor or decode PDCCH) or the UE has enough power to monitor PDCCH using the MR, and the base station supports both PDCCH-based WUS for the MR and the WUR, the base station may transmit a WUS using a format compatible with the MR, the WUR, or both the MR and the WUR, and the UE may monitor any of these WUS. In some examples, during one of the communication modes described above, the base station may further indicate, within a communication mode, which WUS and with which radio the UE should monitor (e.g., DCI-based WUS using MR, DCI-based-WUS using WUR, sequence-based WUS using WUR, OOK-based WUS using WUR, or a combination thereof). For example, a UE, a base station, or a network may determine that the UE is to utilize PDCCH-based DCI, sequence-based signals, or OOK/ASK/FSK based modulated waveforms at a particular time and the type of radio (e.g., MR or WUR) the UE may monitor. A network may use one or more of WUS types (e.g., PDCCH-based DCI, sequence-based signals, or OOK/ASK/FSK based modulated waveforms) monitored by WUR or a PDCCH-based DCI or sequence-based signal using MR based on current communication mode, network sensitivity, coverage characteristics, and priority and QoS of the UE's data. In some examples, the MR WUS sensitivity may be higher than WUR WUS (with all types of WUS, including PDCCH-based DCI, due to, for example, different coding or increased noise for WUR). For higher priority and QoS traffic or for improved coverage, a base station may indicate to a UE to use MR to monitor WUS. In some examples, the types of LP-SS, LP-RS, and LP-sync-preamble signal may change based on the type of LP-WUS. For example, an SSB, CSI-RS, TRS, or DMRS like LP-SS/LP-RS/LP-sync-preamble signal may be associated with a PDCCH-based DCI (polar-coded) while a sequence-based or OOK-based LP-SS or LP-sync-preamble signal may be associated with a sequence-based or OOK-based LP-WUS.

In some aspects, communication modes in the sequence of communication modes may include different configurations for monitoring one or more of: an LP-RS, an LP-SS, an LP-WUS, or an LP-sync-preamble signal within a corresponding time interval. For example, referring to FIG. 12C, communication modes 1222, 1224, 1226 in the sequence of communication modes (1222, 1224, 1226) may include different configurations for monitoring one or more of: an LP-RS (at 1224, 1226), an LP-SS (at 1226), an LP-WUS (at 1222, 1224, 1226), or an LP-sync-preamble signal within a corresponding time interval.

In some aspects, each of the communication modes may be further associated with a frequency bandwidth, and each of the communication modes may be related to monitoring one or more of: the LP-RS, the LP-SS, or the LP-WUS using the corresponding frequency bandwidth within the corresponding time interval. For example, referring to FIG. 13A, each of the communication modes 1302, 1304, 1306 may be further associated with a frequency bandwidth BW1, BW2, BW3. Each of the communication modes 1302, 1304, 1306 may be related to monitoring one or more of: the LP-RS, the LP-SS, or the LP-WUS using the corresponding frequency bandwidth (BW1, BW2, or BW3) within the corresponding time interval.

In some aspects, each of the communication modes may be associated with an indication signal within the corresponding frequency bandwidth at the beginning of the corresponding time interval, and the indication signals for the communication modes may be assigned in a frequency domain. For example, referring to FIG. 13B, each of the communication modes 1312, 1314, 1316 may be associated with an indication signal 1318 within the corresponding frequency bandwidth at the beginning of the corresponding time interval. The indication signals 1318 for the communication modes may be assigned in a frequency domain.

In some aspects, the frequency bandwidths for the communication modes may have a shared core frequency band. For example, referring to FIG. 13C, the frequency bandwidths for the communication modes 1322, 1324, 1326 may have a shared core frequency band (the core band 1328).

At 1510, the UE may transmit, to the network entity, an indication of at least one of a first radio or a second radio entering a sleep mode at an end of one of the sequence of communication modes. The second radio may have a lower power consumption than the first radio. For example, referring to FIG. 11, the UE 1102 may transmit, at 1114, to the network entity (base station 1104), an indication of at least one of a first radio (e.g., HP radio) or a second radio (e.g., LP radio) entering a sleep mode at an end of one of the sequence of communication modes.

In some aspects, the UE may perform a communication mode selection process with the network entity. For example, referring to FIG. 11, the UE 1102 may perform, at 1122, a communication mode selection process with the network entity (base station 1104). The UE may perform the communication mode selection process with the network entity through one or more of: an L1 signaling, an L2 signaling, an L3 signaling, UAI, a PHR, an SR, a RACH message, or HARQ-ACK. In one configuration, the L1 signaling may be through dedicated PUCCH resources or dedicated PUSCH resource, the L2 signaling can through MAC-CE, and the L3 signaling may be through RRC.

The communication mode selection process may include one or more of: indicating, to the network entity, a desired communication mode at a designated time, during a designated time duration, or until a new communication mode is indicated by the UE; receiving, from the network entity, an indication of a designated communication mode, wherein the UE is configured to communicate according to the designated communication mode until another communication mode is indicated; indicating, to the network entity, a desired sequence of communication modes; receiving, from the network entity, an indication of a designated sequence of communication modes from multiple sequences of communication modes; indicating, to the network entity, a desired operating state of one or more of the SW component, the FW component, the HW component, or the RF component of the UE, wherein the desired operating state is one of an ON state or an OFF state; receiving, from the network entity, an indication of a designated operating state for one or more of the SW component, the FW component, the HW component, or the RF component of the UE, wherein the designated operating state is one of an ON state or an OFF state; indicating, to the network entity, a desired bandwidth for monitoring for at least one of an LP-WUS, an LP-RS, an LP-SS or an LP-sync-preamble signal, or for operating within a BWP for one of the first radio and the second radio within a corresponding time interval; and receiving, from the network entity, a designated bandwidth for monitoring for at least one of an LP-WUS, an LP-RS, an LP-SS or an LP-sync-preamble signal, or for operating within a BWP for one of the first radio and the second radio within a corresponding time interval. Additionally, the communication mode selection process may further include the UE transmitting to the network entity a desired selection for any of operating/communication modes described above, and the network entity indicating to the UE a designated selection for the corresponding operating/communication mode.

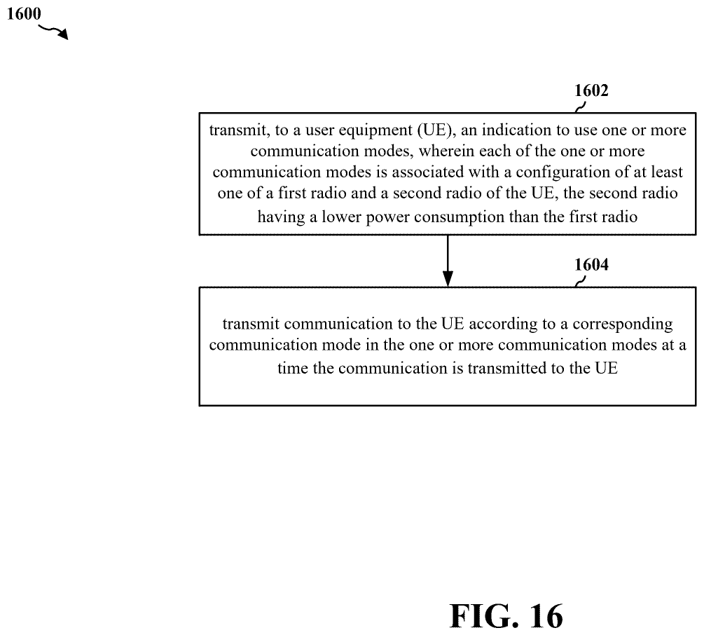

FIG. 16 is a flowchart 1600 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1004, 1104; or the network entity 1802 in the hardware implementation of FIG. 18). The method enables the sequential indication of communication modes (or power saving states, sleeping states, data traffic modes, or modes) related to the WUS for a UE to operate in a more semi-static manner with known patterns of configuration changes. In addition, the method includes the indication of operating certain components, such as an LNA in a WUR, or certain bandwidths for the UE, and the indication may include a core bandwidth or frequency range for the WUR. The method improves the power efficiency of wireless communication.

As shown in FIG. 16, at 1602, the network entity may transmit an indication to use one or more communication modes to a UE. Each of the communication modes may be associated with a configuration of at least one of a first radio and a second radio of the UE. The UE may be the UE 104, 350, 504, 514, 1002, 1102, or the apparatus 1804 in the hardware implementation of FIG. 18. For example, the one or more communication modes may be related to the power states of Table 2 and Table 3, or the sleep type of Table 4. FIGS. 10, 11, 12A, 12B, 12C, 13A, 13B, and 13C illustrate various aspects of the steps in connection with flowchart 1600. For example, referring to FIG. 10, the network entity (base station 1004) may transmit, at 1006, an indication to use one or more communication modes to a UE 1002. For example, the one or more communication modes may be the sequence of communication modes shown in one of FIGS. 12A, 12B, 12C, 13A, 13B, and 13C. That is, the one or more communication modes may be one of the sequences of communication modes 1202 through 1206, 1212 through 1216, 1222 through 1226, 1302 through 1306, 1312 through 1316, or 1322 through 1326.

At 1604, the network entity may transmit communication to the UE according to a corresponding communication mode in the one or more communication modes at a time the communication is transmitted to the UE. For example, referring to FIG. 10, the network entity (base station 1004) may, at 1010, transmit communication to the UE 1002 according to a corresponding communication mode in the one or more communication modes at a time the communication is transmitted to the UE 1002.

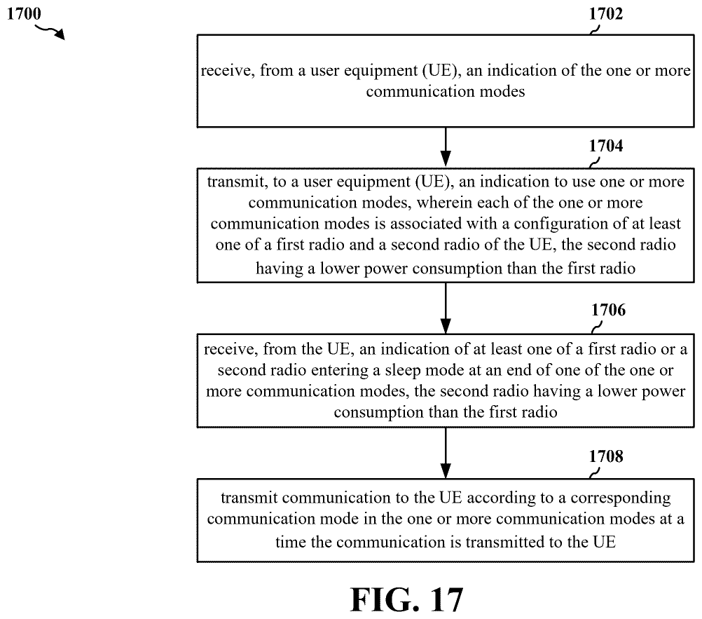

FIG. 17 is a flowchart 1700 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1004, 1104; or the network entity 1802 in the hardware implementation of FIG. 18). The method enables the sequential indication of communication modes (or power saving states, sleeping states, data traffic modes, or modes) related to the WUS for a UE to operate in a more semi-static manner with known patterns of configuration changes. In addition, the method includes the indication of operating certain components, such as an LNA in a WUR, or certain bandwidths for the UE, and the indication may include a core bandwidth or frequency range for the WUR. The method improves the power efficiency of wireless communication.

As shown in FIG. 17, at 1704, the network entity may transmit an indication to use one or more communication modes to a UE. Each of the communication modes may be associated with a configuration of at least one of a first radio and a second radio of the UE. The UE may be the UE 104, 350, 504, 514, 1002, 1102, or the apparatus 1804 in the hardware implementation of FIG. 18. For example, the one or more communication modes may be related to the power states of Table 2 and Table 3, or the sleep type of Table 4. FIGS. 10, 11, 12A, 12B, 12C, 13A, 13B, and 13C illustrate various aspects of the steps in connection with flowchart 1700. For example, referring to FIG. 10, the network entity (base station 1004) may transmit, at 1006, an indication to use one or more communication modes to a UE 1002. For example, the one or more communication modes may be the sequence of communication modes shown in one of FIGS. 12A, 12B, 12C, 13A, 13B, and 13C. That is, the one or more communication modes may be one of the sequences of communication modes 1202 through 1206, 1212 through 1216, 1222 through 1226, 1302 through 1306, 1312 through 1316, or 1322 through 1326.

At 1708, the network entity may transmit communication to the UE according to a corresponding communication mode in the one or more communication modes at a time the communication is transmitted to the UE. For example, referring to FIG. 10, the network entity (base station 1004) may, at 1010, transmit communication to the UE 1002 according to a corresponding communication mode in the one or more communication modes at a time the communication is transmitted to the UE 1002.

In some aspects, the configuration of at least one of the first radio and the second radio may be associated with at least one of: a sleep mode for at least one of the first radio or the second radio of the UE; a power mode for at least one of the first radio or the second radio of the UE; one or more predicted data arrival traffic for at least one of data transmission or data reception by the UE; at least one of priority, QoS, and latency of the one or more predicted data arrival traffic for at least one of data transmission or data reception by the UE; or coverage and communications sensitivity requirements of the network entity. For example, referring to FIGS. 5A, 5B, and 10, when the UE 1002 receives, at 1006, an indication to use one or more of communication modes each associated with a configuration of at least one of the first radio (e.g., the HP radio) and the second radio (e.g., the LP radio), the configuration of at least one of the first radio (e.g., HP radio) and the second radio (e.g., the LP radio) may be associated with at least one of: a sleep mode for at least one of the first radio (e.g., HP radio) or the second radio (e.g., the LP radio) of the UE 1002; a power mode for at least one of the first radio (e.g., HP radio) or the second radio (e.g., the LP radio) of the UE 1002; one or more predicted data arrival traffic for at least one of data transmission or data reception by the UE 1002; at least one of priority, QoS, and latency of the one or more predicted data arrival traffic for at least one of data transmission or data reception by the UE 1002; or coverage and communications sensitivity requirements of the network entity (base station 1004). The power mode may be one of the power states of Table 2 and Table 3, and the sleep mode may be one of the sleep types of Table 4.

In some aspects, the configuration for each of the one or more communication modes may include, but not be limited to, one or more of: one or more of an active or inactive SW component, an active or inactive FW component, an active or inactive HW component, or an active or inactive RF component to be used by at least one of the first radio or the second radio of the UE; one or more of DRX configurations to be used by at least one of the first radio or the second radio based on an RRC state; one or more of first components in the UE to be used for processing complex signals using the first radio or the second radio; one or more of second components in the UE to be used for processing polar decoding using the first radio or the second radio; a capability to process a signal in at least one of a time domain or a frequency domain using the first radio or the second radio; a time for one or more of: performing decoding or detection of the WUS or one or more of LP-RS, LP-SS, LP-sync-preamble signal processing using the first radio or the second radio; PDCCH monitoring occasions on at least one search space group associated with the first radio or the second radio of the UE; a time and frequency configuration for the communication of the UE associated with one of the first radio or the second radio; a periodicity configuration for the communication of the UE associated with one of the first radio or the second radio; a bandwidth configuration for the communication of the UE using the first radio or the second radio; and an SCS configuration for the communication of the UE using the first radio or the second radio.

In some aspects, the configuration for each of the one or more communication modes may further include one or more of: a measurement configuration for RRM for one or more of a serving cell or nearby cells of the UE using the first radio or the second radio; a measurement configuration for a relaxation of RRM for one or more of a serving cell or nearby cells or for at least one type of an intra-frequency type or an inter-frequency type of the UE using the first radio or the second radio; a measurement configuration for allowing an RRM measurement offloading for at least one of serving cell RRM measurements or nearby cells RRM measurements and for at least an RRM measurement type of the inter-frequency type or the intra-frequency type from the first radio to the second radio or from the second radio to the first radio; and a monitoring configuration for monitoring for one or more of an SSB, a system information change, or an SIB signal using the first radio or the second radio. For example, referring to FIG. 10, when the network entity (base station 1004) transmits, at 1006, an indication to use one or more of communication modes to the UE 1002, the configuration for each of the one or more communication modes may further include one or more of the configurations listed above.

In some aspects, each of the one or more communication modes may be associated with the configuration of at least one of the first radio and the second radio during one of: an RRC connected state, an RRC idle state, or an RRC inactive state. The one or more communication modes further include one or more of: a first DRX configuration for monitoring a WUR by the second radio; a second DRX configuration for monitoring a paging occasion by the second radio during the RRC inactive state; and a third DRX configuration for paging monitoring by the second radio during the RRC idle state. For example, referring to FIG. 10, when the network entity (base station 1004) transmits, at 1006, an indication to use one or more of communication modes to the UE 1002, each of the one or more communication modes may be associated with the configuration of at least one of the first radio (e.g., HP radio) and the second radio (e.g., LP radio) during one of: an RRC connected state, an RRC idle state, or an RRC inactive state. The one or more communication modes may further include one or more of: a first DRX configuration for monitoring a WUR by the second radio (e.g., LP radio); a second DRX configuration for monitoring a paging occasion by the second radio (e.g., LP radio) during the RRC inactive state; and a third DRX configuration for paging monitoring by the second radio (e.g., LP radio) during the RRC idle state.

In some aspects, multiple DRX configurations may be allowed for each RRC state (e.g., the RRC connected state, the RRC idle state, or the RRC inactive state), and a specific DRX configuration for an RRC state may be set or reconfigured through one or more of the L1 signaling, the L2 signaling, and the L3 signaling. In some examples, the signaling for setting or reconfiguring a specific DRX configuration for an RRC state may be associated with the one or more communication modes.

In some aspects, each of the one or more communication modes may correspond to at least one of a BWP and a CC, and the one or more communication modes may be received through one of the RRC or the MAC-CE. For example, referring to FIG. 10, when the network entity (base station 1004) transmits, at 1006, an indication to use one or more of communication modes to the UE 1002, each of the one or more communication modes may correspond to at least one of a BWP and a CC, and the one or more communication modes may be transmitted, at 1006, through one of the RRC or the MAC-CE.

In some aspects, the indication transmitted by the network entity may include a sequence of communication modes, and each of the communication modes may be associated with a time interval. When transmitting a communication to the UE, the network entity may transmit the communication to the UE according to a corresponding communication mode in the sequence of communication modes at a time the communication is transmitted to the UE. For example, the sequence of communication modes may be related to the power states of Table 2 and Table 3, or the sleep type of Table 4. For example, referring to FIG. 11, the network entity (base station 1104) may transmit, at 1108, a configuration including a sequence of communication modes to a UE 1102. For example, the sequence of communication modes may be the sequence of communication modes shown in one of FIGS. 12A, 12B, 12C, 13A, 13B, and 13C. That is, the sequence of communication modes may be one of the sequences of communication modes 1202 through 1206, 1212 through 1216, 1222 through 1226, 1302 through 1306, 1312 through 1316, or 1322 through 1326. For example, referring to FIG. 11, the network entity (base station 1104) may transmit, at 1116, communication to the UE 1102 according to a corresponding communication mode in the sequence of communication modes at a time the communication is transmitted to the UE 1102.

In some aspects, each communication mode in the sequence of communication modes may be associated with the first radio or the second radio. For example, referring to FIG. 5A, the first radio may be the high-power radio component 506 of the UE 504, and the second radio may be the low-power radio component 508 of the UE 504.

In some aspects, the sequence of communication modes may correspond to at least one of a BWP and a CC, and the configuration may be transmitted through one of the RRC or the MAC-CE. For example, referring to FIG. 11, the sequence of communication modes transmitted by the base station 1104 at 1108 may correspond to at least one of a BWP and a CC, and the configuration the network entity (base station 1104) transmits at 1108 may be transmitted through one of the RRC or the MAC-CE.

At 1702, the network entity may receive, from the UE, an indication of the sequence of communication modes prior to transmitting the configuration of the sequence of communication modes. For example, referring to FIG. 11, the network entity (base station 1104) may, at 1106, receive an indication of the sequence of communication modes from the UE 1102, prior to transmitting, at 1108, the configuration of the sequence of communication modes. The base station 1104 may transmit, at 1108, the configuration including the sequence of communication modes based on the indication received, at 1106, from the UE 1102.

In some aspects, the time and frequency configuration may include one or more: a first configuration for monitoring for a PDCCH with a corresponding radio at the UE; a second configuration for monitoring one or more of: an CSI-RS, a TRS, a PTRS, an SRS for reception at the first radio; a third configuration including a WUS configuration and a preamble signal configuration. The WUS configuration may be for monitoring at least one of an LP-WUS, an LP-RS, or an LP-SS. The preamble signal configuration may be for monitoring an LP-sync-preamble signal associated with the LP-WUS with the second radio. The LP-sync-preamble signal may be a part of the LP-WUS configuration. The configuration for an LP-sync-preamble signal, such as its bandwidth, duration, periodicity, may be the same as or different from the configuration of the LP-WUS signal. In some examples, the LP-SS, LP-RS, LP-sync-preamble signal, LP-WUS may be monitored by the same group of UEs. In some other examples, each resource of LP-SS, LP-RS, LP-sync-preamble signal, LP-WUS may be associated with its own group of UEs. The LP-SS may be continuously transmitted signal (e.g., like SSB), while an LP-sync-preamble signal may be transmitted less frequently. In some cases, an LP-sync-preamble signal may be associated with an LP-WUS. In some other cases, an LP-sync-preamble signal maybe associated with a WUS but can be sent in some time WUS is not present.

In some examples, the LP-sync-preamble length may depend on whether there is a present LP-SS nearby the LP-WUS associated with the LP-sync-preamble signal. In some examples, an LP-sync-preamble signal that is transmitted from the base station after X₁ time units (X₁<Y) from an LP-SS might be canceled or be configured with a size/length that is smaller than another LP-sync-preamble signal that is transmitted after X₂ time units (X₂>=Y), where Y is a threshold configured by the base station using L1/L2/L3 signaling communicated to the first radio or the second radios.

The time and frequency configuration may further include a fourth configuration of reporting CSI, HARQ-ACK, a BSR, or requesting an SR; and a repetition factor for one or more of: the SRS, the CSI-RS, the PTRS, the TRS, the LP-SS, the LP-WUS, the LP-sync-preamble signal, the LP-RS, the HARQ-ACK, and the CSI.

In some aspects, an LP resource set may be defined. The LP resource set may include a LP-WUS resource and a LP-sync-preamble resource. In some examples, an LP resource set may include multiple resources for LP-WUS and multiple resource for LP-sync-preamble signal. The number resource for WUS and the number of resources for LP-sync-preamble may be the same or different.

In some aspects, an LP resource set may be defined. The LP resource set may include a resource for each of LP-RS, LP-SS, LP-WUS, and LP-sync-preamble signal. Each of these resources may have its own configuration. The LP resource set may include multiple resources for each of LP-RS, LP-SS, LP-WUS, and LP-sync-preamble signal, and each resource may have its configuration defining, for example, the repetition or the periodicity of these signals.

The periodicity configuration may include one or more of: a first periodicity for monitoring for the PDCCH with a corresponding radio at the UE; a second periodicity for monitoring one or more of: the CSI-RS, the TRS, the PTRS, the SRS for the reception at the first radio; a third periodicity for monitoring the LP-RS or the LP-SS with the second radio; and a fourth periodicity of reporting the CSI, the HARQ-ACK, the BSR, or requesting the SR.

The bandwidth configuration for the communication of the UE may include the bandwidth for monitoring for at least one of an LP-WUS, an LP-RS, or an LP-SS, or for operating within a BWP for the first radio within a corresponding time interval. The SCS configuration for the communication of the UE may include the SCS for monitoring for at least one of the LP-WUS, the LP-RS, or the LP-SS, or for operating within the BWP for the first radio within a corresponding time interval. For example, referring to FIG. 11, when the network entity (base station 1104) transmits, at 1108, a configuration including a sequence of communication modes to the UE 1102. One or more communication modes in the sequence of communication modes may include a time and frequency configuration, a periodicity configuration, a bandwidth configuration and an SCS configuration. The time and frequency configuration, the periodicity configuration, the bandwidth configuration, and the SCS configuration may include one or more of the respective configurations described above.

In some aspects, each of the LP-WUS, the LP-RS, and the LP-SS may be one of: a coded control signal, a sequential-based signal, or an OOK-based waveform signal. For example, referring to FIG. 12C, when the sequence of communication modes 1222, 1224, 1226 are related to monitoring LP-WUS, LP-WUS, LP-RS, LP-SS or a combination of these signals at one or more of the communication modes 1222, 1224, 1226, the LP-WUS, the LP-RS and the LP-SS may be one of: a coded control signal, a sequential-based signal, or an OOK-based waveform signal.

In some aspects, the LP-WUS payload, which may be group specific to wake up a group, may be different from one communication mode to another communication mode, or from one RRC state to another RRC state. Therefore, based on the RRC state or the communication mode, a UE may determine the LP-WUS payload (which may be used to wake up). The LP-WUS payload may be a part of the configuration. The same principle may be applicable to LP-RS and LP-SS. That is, the payload of LP-RS (or LP-SS) may be a part of the configuration and may be determined based on the communication mode or the RRC state.

In some aspects, an RNTI or a scrambling ID for scrambling an LP-WUS may be communication mode or RRC mode specific. If an LP-SS or an LP-RS is generated using scrambling IDs, different scrambling IDs may be used for each communication mode and for each RRC state.

In some aspects, each of the communication modes may be related to one or more components at the UE being in an ON state or an OFF state within a corresponding time interval. The components may include one or more of: the SW component, the FW component, the HW component, or the RF component. For example, referring to FIG. 12A, the sequence of communication modes 1202, 1204, 1206 may be related to a radio frequency component (e.g., an LNA) at the UE being in an ON state (at 1202 and 1206) or an OFF state (at 1204).

In some aspects, communication modes in the sequence of communication modes may include different configurations to monitor for one or more of LP-WUS or PDCCH-based WUS within a corresponding time interval. For example, referring to FIG. 12B, communication modes 1212, 1214, 1216 in the sequence of communication modes (1212, 1214, 1216) may include different configurations to monitor for one or more of LP-WUS (at 1212) or PDCCH-based WUS (at 1214, 1216) within a corresponding time interval.

In some aspects, communication modes in the sequence of communication modes may include different configurations for monitoring one or more of: an LP-RS, an LP-SS, an LP-sync-preamble signal or an LP-WUS within a corresponding time interval. For example, referring to FIG. 12C, communication modes 1222, 1224, 1226 in the sequence of communication modes (1222, 1224, 1226) may include different configurations for monitoring one or more of: an LP-RS (at 1224, 1226), an LP-SS (at 1226), an LP-sync-preamble signal, or an LP-WUS (at 1222, 1224, 1226) within a corresponding time interval.

In some aspects, each of the communication modes may be further associated with a frequency bandwidth, and each of the communication modes may be related to monitoring one or more of: the LP-RS, the LP-SS, LP-sync-preamble signal, or the LP-WUS using the corresponding frequency bandwidth within the corresponding time interval. For example, referring to FIG. 13A, each of the communication modes 1302, 1304, 1306 may be further associated with a frequency bandwidth BW1, BW2, BW3. Each of the communication modes 1302, 1304, 1306 may be related to monitoring one or more of: the LP-RS, the LP-SS, LP-sync-preamble signal, or the LP-WUS using the corresponding frequency bandwidth (BW1, BW2, or BW3) within the corresponding time interval.

In some aspects, each of the communication modes may be associated with an indication signal within the corresponding frequency bandwidth at the beginning of the corresponding time interval, and the indication signals for the communication modes may be assigned in a frequency domain. For example, referring to FIG. 13B, each of the communication modes 1312, 1314, 1316 may be associated with an indication signal 1318 within the corresponding frequency bandwidth at the beginning of the corresponding time interval. The indication signals 1318 for the communication modes may be assigned in a frequency domain.

In some aspects, the frequency bandwidths for the communication modes may have a shared core frequency band. For example, referring to FIG. 13C, the frequency bandwidths for the communication modes 1322, 1324, 1326 may have a shared core frequency band (the core band 1328).

At 1706, the network entity may receive, from the UE, an indication of at least one of a first radio or a second radio entering a sleep mode at an end of one of the sequence of communication modes. The second radio may have a lower power consumption than the first radio. For example, referring to FIG. 11, the network entity (base station 1104) may receive, at 1114, from the UE 1102, an indication of at least one of a first radio or a second radio entering a sleep mode at an end of one of the sequence of communication modes.

In some aspects, the network entity may perform a communication mode selection process with the UE. For example, referring to FIG. 11, the network entity (base station 1104) may perform, at 1122, a communication mode selection process with the UE 1102. The network entity may perform the communication mode selection process with the UE through one or more of: an L1 signaling, an L2 signaling, an L3 signaling, UAI, a PHR, an SR, a RACH message, or HARQ-ACK. In one configuration, the L1 signaling may be through dedicated PUCCH resources or dedicated PUSCH resource, the L2 signaling can through MAC-CE, and the L3 signaling may be through RRC.

The communication mode selection process may include one or more of: receiving, from the UE, a desired communication mode at a designated time, during a designated time duration, or until a new communication mode is indicated by the UE; indicating, to the UE, an indication of a designated communication mode, wherein the UE is configured to communicate according to the designated communication mode until another communication mode is indicated; receiving, from the UE, a desired sequence of communication modes; indicating, to the UE, an indication of a designated sequence of communication modes from multiple sequences of communication modes; receiving, from the UE, a desired operating state of one or more of the SW component, the FW component, the HW component, or the RF component of the UE, wherein the desired operating state is one of an ON state or an OFF state; indicating, to the UE, an indication of a designated operating state for one or more of the SW component, the FW component, the HW component, or the RF component of the UE, wherein the designated operating state is one of an ON state or an OFF state; receiving, from the UE, a desired bandwidth for monitoring for at least one of an LP-WUS, an LP-RS, an LP-SS or an LP-sync-preamble signal, or for operating within a BWP for one of the first radio and the second radio within a corresponding time interval; and indicating, to the UE, a designated bandwidth for monitoring for at least one of an LP-WUS, an LP-RS, an LP-SS or an LP-sync-preamble signal, or for operating within a BWP for one of the first radio and the second radio within a corresponding time interval. Additionally, the communication mode selection process may further include the UE transmitting to the network entity a desired selection for any of operating/communication modes described above, and the network entity indicating to the UE a selection for the corresponding operating/communication mode.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver), which include a low power transceiver 1823. The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

As discussed supra, the component 198 is configured to receive, from a network entity, an indication to use one or more communication modes, wherein each of the communication modes is associated with a configuration of at least one of a first radio and a second radio (e.g., low power transceiver 1823) of the UE. The second radio may have a lower power consumption than the first radio. The component 198 may be further configured to monitor for communication from the network entity according to at least one of the one or more communication modes. The component 198 may be further configured to perform any of the aspects described in connection with the flowchart in FIG. 14, FIG. 15, and/or performed by the UE 1002, 1102 in FIG. 10 and FIG. 11, respectively. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, includes means for receiving, from a network entity, an indication to use one or more communication modes, wherein each of the communication modes is associated with a configuration of at least one of a first radio and a second radio of the UE. The second radio may have a lower power consumption than the first radio. The apparatus 1804 may further include means for monitoring for communication from the network entity according to at least one of the one or more communication modes. The apparatus 1804 may further include means for performing any of the aspects described in connection with the flowcharts in FIGS. 14 and 15, and/or the aspects performed by the UE 1002, 1102 in FIG. 10 and FIG. 11, respectively. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

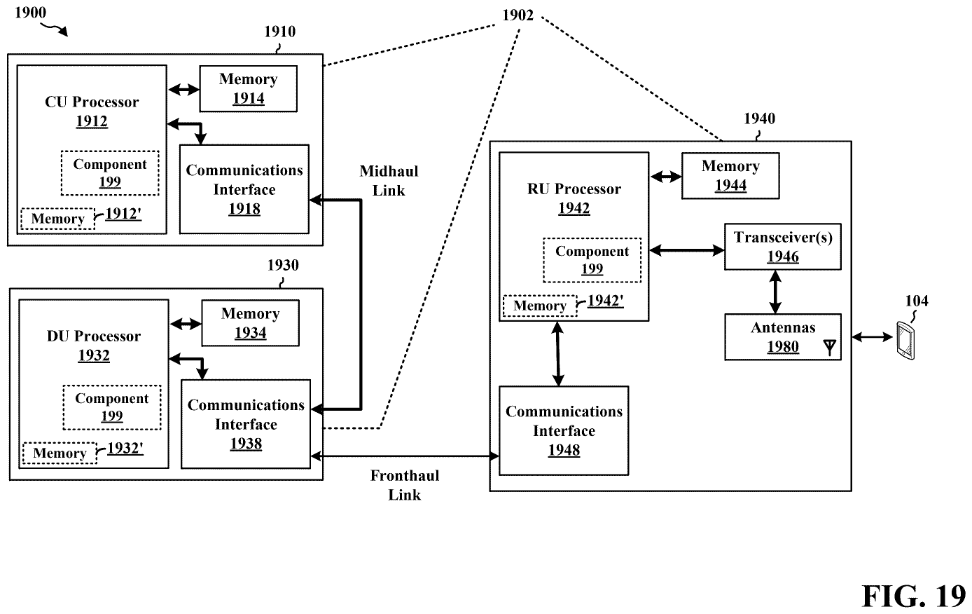

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit, to a UE, an indication to use one or more communication modes. Each of the communication modes may be associated with a configuration of at least one of a first radio and a second radio of the UE. The second radio may have a lower power consumption than the first radio. The component 199 may be further configured to transmit communication to the UE according to a corresponding communication mode in the one or more communication modes at a time the communication is transmitted to the UE. The component 199 may be further configured to perform any of the aspects described in connection with the flowchart in FIG. 16, FIG. 17, and/or performed by the base station 1004, 1104 in FIG. 10 and FIG. 11, respectively. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 includes means for transmitting, to a UE, an indication to use one or more communication modes. Each of the communication modes may be associated with a configuration of at least one of a first radio and a second radio of the UE. The second radio may have a lower power consumption than first radio. The network entity 1902 may further include means for transmitting communication to the UE according to a corresponding communication mode in the one or more of communication modes at a time the communication is transmitted to the UE. The network entity 1902 may further include means for performing any of the aspects described in connection with the flowcharts in FIGS. 16 and 17, and/or the aspects performed by the base station 1004, 1104 in FIG. 10 and FIG. 11, respectively. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, an indication to use one or more communication modes. Each of the communication modes may be associated with a configuration of at least one of a first radio and a second of the UE. The second radio may have a lower power consumption than the first radio. The method may further include monitoring for communication from the network entity according to at least one of the one or more communication modes. The method enables the sequential indication of communication modes (or power saving states, sleeping states, data traffic modes, or modes) related to the WUS for a UE to operate in a more semi-static manner with known patterns of configuration changes. In addition, the method includes the indication of operating certain components, such as an LNA in a WUR, or certain bandwidths for the UE, and the indication may include a core bandwidth or frequency range for the WUR. The method improves the power efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes: receiving, from a network entity, an indication to use one or more communication modes, where each of the one or more communication modes is associated with a configuration of at least one of a first radio and a second radio of the UE; and monitor, according to at least one of the one or more communication modes, for communication from the network entity.

Aspect 2 is the method of aspect 1, where the second radio has a lower power consumption than the first radio.

Aspect 3 is the method of aspect 2, where the configuration of at least one of the first radio and the second radio is associated with at least one of: a sleep mode for at least one of the first radio or the second radio of the UE; a power mode for at least one of the first radio or the second radio of the UE; one or more predicted data arrival traffic for at least one of data transmission or data reception by the UE; at least one of priority, QoS, and latency of the one or more predicted data arrival traffic for at least one of data transmission or data reception by the UE; or coverage and communications sensitivity requirements of the network entity.

Aspect 4 is the method of any of aspects 1 and 2, where a communication mode configuration for each of the one or more communication modes includes one or more of one or more of an active or inactive SW component, an active or inactive FW component, an active or inactive HW component, or an active or inactive RF component to be used by at least one of the first radio or the second radio of the UE; one or more of DRX configurations to be used by at least one of the first radio or the second radio based on an RRC state; one or more of first components in the UE to be used for processing complex signals using the first radio or the second radio; one or more of second components in the UE to be used for processing polar decoding using the first radio or the second radio; a capability to process a signal in at least one of a time domain or a frequency domain using the first radio or the second radio; a time for one or more of: performing decoding or detection of the WUS or one or more of LP-RS, LP-SS, LP-sync-preamble signal processing using the first radio or the second radio; PDCCH monitoring occasions on at least one search space group associated with the first radio or the second radio of the UE; a time and frequency configuration for the communication of the UE associated with one of the first radio or the second radio; a periodicity configuration for the communication of the UE associated with one of the first radio or the second radio; a bandwidth configuration for the communication of the UE using the first radio or the second radio; an SCS configuration for the communication of the UE using the first radio or the second radio; a measurement configuration for RRM for one or more of a serving cell or nearby cells of the UE using the first radio or the second radio; a measurement configuration for a relaxation of RRM for one or more of a serving cell or nearby cells or for at least one type of an intra-frequency type or an inter-frequency type of the UE using the first radio or the second radio; a measurement configuration for allowing an RRM measurement offloading for at least one of serving cell RRM measurements or nearby cells RRM measurements and for at least an RRM measurement type of the inter-frequency type or the intra-frequency type from the first radio to the second radio or from the second radio to the first radio; and a monitoring configuration for monitoring for one or more of an SSB, a system information change, or an SIB signal using the first radio or the second radio.

Aspect 5 is the method of aspect 4, wherein each of the one or more communication modes is associated with the configuration of at least one of the first radio and the second radio during one of: an RRC connected state, an RRC idle state, or an RRC inactive state. The one or more communication modes further include one or more of: a first DRX configuration for monitoring a WUR by the second radio; a second DRX configuration for monitoring a paging occasion by the second radio during the RRC inactive state; and a third DRX configuration for paging monitoring by the second radio during the RRC idle state.

Aspect 6 is the method of aspect 4, where each of the one or more communication modes corresponds to at least one of a BWP and a CC. The one or more communication modes are received through one of the RRC or the MAC-CE.

Aspect 7 is the method of aspect 4, where the indication includes a sequence of communication modes, and each communication mode of the sequence of communication modes is associated with a time interval, and where monitoring for communication from the network entity includes: monitoring, according to the sequence of communication modes, for communication from the network entity using the first radio or the second radio.

Aspect 8 is the method of aspect 7, where the method further includes transmitting, to the network entity, an expected transition time, wherein the expected transition time may be one of a first time between adjacent communication modes of the sequence of communication modes, or a second time between a receiving time the second radio receiving an LP-WUS and a wakeup time when the first radio wakes up or is able to monitor PDCCH monitoring occasions; and receiving, from the network entity, a transition indication to operate in the transition mode, wherein an actual transition time of the transition mode is set by the UE based on a configuration of the at least one of the first radio and the second radio of the UE.

Aspect 9 is the method of aspect 7, where the method further includes signaling, to the network entity, an indication of the sequence of communication modes, prior to receiving the configuration.

Aspect 10 is the method of aspect 7, where the time and frequency configuration may include one or more: a first configuration for monitoring for a PDCCH with a corresponding radio at the UE; a second configuration for monitoring one or more of: an CSI-RS, a TRS, a PTRS, an SRS for reception at the first radio; a third configuration including a WUS configuration and a preamble signal configuration. The WUS configuration may be for monitoring at least one of an LP-WUS, an LP-RS, or an LP-SS. The preamble signal configuration may be for monitoring an LP-sync-preamble signal associated with the LP-WUS with the second radio. The time and frequency configuration may further include a fourth configuration of reporting CSI, HARQ-ACK, a BSR, or requesting an SR; and a repetition factor for one or more of: the SRS, the CSI-RS, the PTRS, the TRS, the LP-SS, the LP-WUS, the LP-sync-preamble signal, the LP-RS, the HARQ-ACK, and the CSI. The periodicity configuration includes one or more of: a first periodicity for monitoring for the PDCCH with a corresponding radio at the UE; a second periodicity for monitoring one or more of: the CSI-RS, the TRS, the PTRS, the SRS for the reception at the first radio; a third periodicity for monitoring the LP-RS or the LP-SS with the second radio; and a fourth periodicity of reporting the CSI, the HARQ-ACK, the BSR, or requesting the SR. The bandwidth configuration for the communication of the UE includes: the bandwidth for monitoring for at least one of an LP-WUS, an LP-RS, or an LP-SS, or for operating within the BWP for the first radio within a corresponding time interval. The SCS configuration for the communication of the UE includes: the SCS for monitoring for at least one of the LP-WUS, the LP-RS, or the LP-SS, or for operating within the BWP for the first radio within a corresponding time interval, wherein each of the LP-WUS, the LP-RS, and the LP-SS is one of: a coded control signal, a sequential-based signal, or an OOK-based waveform signal.

Aspect 11 is the method of aspect 7, where each of the communication modes is related to the one or more components of the UE being in an ON state or an OFF state within a corresponding time interval. The components may include one or more of: the SW component, the FW component, the HW component, or the RF component.

Aspect 12 is the method of aspect 7, where communication modes in the sequence of communication modes include different configurations for monitoring one or more of: an LP-WUS, a PDCCH-based WUS, an LP-RS, an LP-SS, or an LP-sync-preamble signal within a corresponding time interval.

Aspect 13 is the method of aspect 12, where each of the communication modes is further associated with a frequency bandwidth, and each of the communication modes is related to monitoring one or more of: the LP-RS, the LP-SS, or the LP-WUS using a corresponding frequency bandwidth within the corresponding time interval, wherein frequency bandwidths for the communication modes have a shared core frequency band.

Aspect 14 is the method of aspect 13, where each of the communication modes is associated with an indication signal within the corresponding frequency bandwidth at the beginning of the corresponding time interval, and the indication signals for the communication modes are assigned in a frequency domain.

Aspect 15 is the method of any of aspects 6 to 14, where the method further includes: transmitting, to the network entity, an indication of at least one of the first radio or the second radio entering a sleep mode at an end of one of the sequence of communication modes.

Aspect 16 is an apparatus for wireless communication at a UE, including: a memory; and at least one processor coupled to the memory and, based at least in part on information stored in the memory, the at least one processor is configured to perform the method of any of aspects 1-15.

Aspect 17 is an apparatus for wireless communication including means for implementing the method of any of aspects 1-15.

Aspect 18 is a computer-readable medium (e.g., a non-transitory computer-readable medium) storing computer executable code, where the code when executed by a processor causes the processor to implement the method of any of aspects 1-15.

Aspect 19 is a method of wireless communication at a network entity. The method includes: transmitting, to a UE, an indication to use one or more communication modes, where each of the communication modes is associated with a configuration of at least one of a first radio and a second radio of the UE, wherein the second radio has a lower power consumption than the first radio; and transmitting communication to the UE according to a corresponding communication mode in the one or more communication modes at a time the communication is transmitted to the UE.

Aspect 20 is the method of aspect 19, where the configuration of at least one of the first radio and the second radio is associated with at least one of: a sleep mode for at least one of the first radio or the second radio of the UE; a power mode for at least one of the first radio or the second radio of the UE; one or more predicted data arrival traffic for at least one of data transmission or data reception by the UE; at least one of priority, QoS, and latency of the one or more predicted data arrival traffic for at least one of data transmission or data reception by the UE; or coverage and communications sensitivity requirements of the network entity.

Aspect 21 is the method of any of aspects 19 to 20, where a configuration for each of the one or more communication modes includes one or more of one or more of an active or inactive SW component, an active or inactive FW component, an active or inactive HW component, or an active or inactive RF component to be used by at least one of the first radio or the second radio of the UE; one or more of DRX configurations to be used by at least one of the first radio or the second radio based on an RRC state; one or more of first components in the UE to be used for processing complex signals using the first radio or the second radio; one or more of second components in the UE to be used for processing polar decoding using the first radio or the second radio; a capability to process a signal in at least one of a time domain or a frequency domain using the first radio or the second radio; a time indication for one or more of: performing decoding or detection of the WUS or one or more of LP-RS, LP-SS, LP-sync-preamble signal processing using the first radio or the second radio; PDCCH monitoring occasions on at least one search space group associated with the first radio or the second radio of the UE; a time and frequency configuration for the communication of the UE associated with one of the first radio or the second radio; a periodicity configuration for the communication of the UE associated with one of the first radio or the second radio; a bandwidth configuration for the communication of the UE using the first radio or the second radio; an SCS configuration for the communication of the UE using the first radio or the second radio; a measurement configuration for RRM for one or more of a serving cell or nearby cells of the UE using the first radio or the second radio; a measurement configuration for a relaxation of RRM for one or more of a serving cell or nearby cells or for at least one type of an intra-frequency type or an inter-frequency type of the UE using the first radio or the second radio; a measurement configuration for allowing an RRM measurement offloading for at least one of serving cell RRM measurements or nearby cells RRM measurements and for at least an RRM measurement type of the inter-frequency type or the intra-frequency type from the first radio to the second radio or from the second radio to the first radio; and a monitoring configuration for monitoring for one or more of an SSB, a system information change, or an SIB signal using the first radio or the second radio.

Aspect 22 is the method of any of aspects 19 to 21, wherein each of the one or more communication modes is associated with the configuration of at least one of the first radio and the second radio during one of: an RRC connected state, an RRC idle state, or an RRC inactive state. The one or more communication modes further include one or more of: a first DRX configuration for monitoring a WUR by the second radio; a second DRX configuration for monitoring a paging occasion by the second radio during the RRC inactive state; and a third DRX configuration for paging monitoring by the second radio during the RRC idle state.

Aspect 23 is the method of any of aspects 19 to 21, where each of the one or more communication modes corresponds to at least one of a BWP and a CC. The one or more communication modes are received through one of the RRC or the MAC-CE.

Aspect 24 is the method of aspect 21, where wherein the indication includes a sequence of communication modes. Each communication mode of the sequence of communication modes is associated with a time interval, and where, transmitting communication to the UE includes: transmitting the communication to the UE according to a corresponding communication mode in the sequence of communication modes at a time the communication is transmitted to the UE.

Aspect 25 is the method of aspect 24, where the method further includes receiving, from the UE, an expected transition time, wherein the expected transition time is one of a time between adjacent communication modes of the sequence of communication modes, or a time between a receiving time the second radio receiving an LP-WUS and a wakeup time when the first radio wakes up or is able to monitor PDCCH monitoring occasions; and transmitting, to the UE, an indication for the UE to operate in the transition mode. An actual transition time of the transition mode is set by the UE based on a configuration of the at least one of the first radio and the second radio of the UE.

Aspect 26 is the method of aspect 24, where the method further includes receiving, from the UE, an indication of the sequence of communication modes prior to transmitting the configuration of the sequence of communication modes.

Aspect 27 is the method of aspect 24, where the time and frequency configuration may include one or more: a first configuration for monitoring for a PDCCH with a corresponding radio at the UE; a second configuration for monitoring one or more of: an CSI-RS, a TRS, a PTRS, an SRS for reception at the first radio; a third configuration including a WUS configuration and a preamble signal configuration. The WUS configuration may be for monitoring at least one of an LP-WUS, an LP-RS, or an LP-SS. The preamble signal configuration may be for monitoring an LP-sync-preamble signal associated with the LP-WUS with the second radio. In some examples, the LP-SS, LP-RS, LP-sync-preamble signal, LP-WUS may be monitored by the same group of UEs. In some other examples, each resource of LP-SS, LP-RS, LP-sync-preamble signal, LP-WUS may be associated with its own group of UEs. The LP-SS may be continuously transmitted signal (e.g., like SSB), while an LP-sync-preamble signal may be transmitted less frequently. In some cases, an LP-sync-preamble signal may be associated with an LP-WUS. In some other cases, an LP-sync-preamble signal maybe associated with a WUS but can be sent in some time WUS is not present.

The time and frequency configuration may further include a fourth configuration of reporting CSI, HARQ-ACK, a BSR, or requesting an SR; and a repetition factor for one or more of: the SRS, the CSI-RS, the PTRS, the TRS, the LP-SS, the LP-WUS, the LP-sync-preamble signal, the LP-RS, the HARQ-ACK, and the CSI. The periodicity configuration includes one or more of: a first periodicity for monitoring for the PDCCH with a corresponding radio at the UE; a second periodicity for monitoring one or more of: the CSI-RS, the TRS, the PTRS, the SRS for the reception at the first radio; a third periodicity for monitoring the LP-RS or the LP-SS with the second radio; and a fourth periodicity of reporting the CSI, the HARQ-ACK, the BSR, or requesting the SR. The bandwidth configuration for the communication of the UE includes: the bandwidth for monitoring for at least one of an LP-WUS, an LP-RS, or an LP-SS, or for operating within the BWP for the first radio within a corresponding time interval. The SCS configuration for the communication of the UE includes: the SCS for monitoring for at least one of the LP-WUS, the LP-RS, or the LP-SS, or for operating within the BWP for the first radio within a corresponding time interval, wherein each of the LP-WUS, the LP-RS, and the LP-SS is one of: a coded control signal, a sequential-based signal, or an OOK-based waveform signal.

Aspect 28 is the method of aspect 24, where each of the communication modes is related to the one or more components of the UE being in an ON state or an OFF state within a corresponding time interval. The components may include one or more of: the SW component, the FW component, the HW component, or the RF component.

Aspect 29 is the method of aspect 24, where communication modes in the sequence of communication modes include different configurations for monitoring one or more of: an LP-WUS, a PDCCH-based WUS, an LP-RS, an LP-SS, or an LP-sync-preamble signal within a corresponding time interval.

Aspect 30 is the method of aspect 29, where each of the communication modes is further associated with a frequency bandwidth, and each of the communication modes is related to monitoring one or more of: the LP-RS, the LP-SS, or the LP-WUS using a corresponding frequency bandwidth within the corresponding time interval, wherein frequency bandwidths for the communication modes have a shared core frequency band.

Aspect 31 is the method of aspect 30, where each of the communication modes is associated with an indication signal within the corresponding frequency bandwidth at the beginning of the corresponding time interval, and the indication signals for the communication modes are assigned in a frequency domain.

Aspect 32 is an apparatus for wireless communication at a network entity, including: a memory; and at least one processor coupled to the memory and, based at least in part on information stored in the memory, the at least one processor is configured to perform the method of any of aspects 19-31.

Aspect 33 is the apparatus of aspect 32, further including at least one of a transceiver or an antenna coupled to the at least one processor and configured to transmit the configuration including the one or more of communication modes.

Aspect 34 is an apparatus for wireless communication including means for implementing the method of any of aspects 19-31.

Aspect 35 is a computer-readable medium (e.g., a non-transitory computer-readable medium) storing computer executable code, where the code when executed by a processor causes the processor to implement the method of any of aspects 19-31.

1. An apparatus for wireless communication at a user equipment (UE), comprising:
a first radio;
a second radio;
memory; and
at least one processor coupled to the memory and configured to:
receive, from a network entity, an indication to use one or more communication modes, wherein each of the one or more communication modes is associated with a configuration of at least one of the first radio and the second radio of the UE; and
monitor, according to at least one of the one or more communication modes, for communication from the network entity.

2. The apparatus of claim 1, wherein the second radio has a lower power consumption than the first radio.

3. The apparatus of claim 2, wherein the configuration of at least one of the first radio and the second radio is associated with at least one of:
a sleep mode for at least one of the first radio or the second radio of the UE;
a power mode for at least one of the first radio or the second radio of the UE;
one or more predicted data arrival traffic for at least one of data transmission or data reception by the UE;
at least one of priority, quality-of-service (QoS), and latency of the one or more predicted data arrival traffic for at least one of the data transmission or the data reception by the UE; and
coverage and communications sensitivity requirements of the network entity.

4. The apparatus of claim 2, wherein a communication mode configuration for each of the one or more communication modes includes one or more of:
one or more of an active or inactive software (SW) component, an active or inactive firmware (FW) component, an active or inactive hardware (HW) component, or an active or inactive radio frequency (RF) component to be used by at least one of the first radio or the second radio of the UE;
one or more of discontinuous reception (DRX) configurations to be used by at least one of the first radio or the second radio based on a radio resource control (RRC) state;
one or more of first components in the UE to be used for processing complex signals using the first radio or the second radio;
one or more of second components in the UE to be used for processing polar decoding using the first radio or the second radio;
a capability to process a signal in at least one of a time domain or a frequency domain using the first radio or the second radio;
a time for one or more of: performing decoding or detection of a wake-up signal (WUS) or one or more of a low power reference signal (LP-RS), a low power synchronization signal (LP-SS), or a low power synchronization preamble (LP-sync-preamble) signal processing using the first radio or the second radio;
PDCCH monitoring occasions on at least one search space group associated with the first radio or the second radio of the UE;
a time and frequency configuration for the communication of the UE associated with one of the first radio or the second radio;
a periodicity configuration for the communication of the UE associated with one of the first radio or the second radio;
a bandwidth configuration for the communication of the UE using the first radio or the second radio;
a subcarrier spacing (SCS) configuration for the communication of the UE using the first radio or the second radio;
a first measurement configuration for radio resource management (RRM) for one or more of a serving cell or nearby cells of the UE using the first radio or the second radio;
a second measurement configuration for a relaxation of the RRM for one or more of the serving cell or the nearby cells or for at least one type of an intra-frequency type or an inter-frequency type of the UE using the first radio or the second radio;
a third measurement configuration for allowing an RRM measurement offloading for at least one of serving cell RRM measurements or nearby cells RRM measurements and for at least an RRM measurement type of the inter-frequency type or the intra-frequency type from the first radio to the second radio or from the second radio to the first radio; and
a monitoring configuration for monitoring for one or more of a synchronization signal block (SSB), a system information change, or a system information block (SIB) signal using the first radio or the second radio.

5. The apparatus of claim 4, wherein each of the one or more communication modes is associated with the configuration of at least one of the first radio and the second radio during one of: an RRC connected state, an RRC idle state, or an RRC inactive state, and wherein the one or more communication modes further include one or more of:
a first discontinuous reception (DRX) configuration for monitoring a WUR by the second radio;
a second DRX configuration for monitoring a paging occasion by the second radio during the RRC inactive state; and
a third DRX configuration for paging monitoring by the second radio during the RRC idle state.

6. (canceled)

7. The apparatus of claim 4, wherein the indication comprises a sequence of communication modes, and each communication mode of the sequence of communication modes is associated with a time interval, and wherein to monitor for the communication from the network entity, the at least one processor is configured to:
monitor, according to the sequence of communication modes, for the communication from the network entity using the first radio or the second radio.

8. The apparatus of claim 7, wherein the at least one processor is further configured to:
transmit, to the network entity, an expected transition time, wherein the expected transition time is one of:
a first time between adjacent communication modes of the sequence of communication modes, or
a second time between a receiving time the second radio receiving a low power wake-up signal (LP-WUS) and a wakeup time when the first radio wakes up or is able to monitor the PDCCH monitoring occasions; and
receive, from the network entity, a transition indication to operate in a transition mode, wherein an actual transition time is set by the UE based on the configuration of the at least one of the first radio and the second radio of the UE.

9. The apparatus of claim 7, wherein the at least one processor is further configured to:
signal, to the network entity, an additional indication of the sequence of communication modes, prior to receiving the configuration.

10. The apparatus of claim 7, wherein the time and frequency configuration corresponds to a start symbol within a slot, a number of symbols, start resource element or resource block, and a number of resource elements or blocks, wherein the time and frequency configuration comprises one or more of:
a first configuration for monitoring for a physical downlink control channel (PDCCH) with a corresponding radio at the UE;
a second configuration for monitoring one or more of: a channel state information reference signal (CSI-RS), a tracking reference signal (TRS), a phase tracking reference signal (PTRS), a sounding reference signal (SRS) for reception at the first radio;
a third configuration including:
a WUS configuration for monitoring at least one of a low power wakeup signal (LP-WUS), the LP-RS, or the LP-SS; and
a preamble signal configuration for monitoring a low power synchronization preamble (LP-sync-preamble) signal associated with the LP-WUS with the second radio;
a fourth configuration of reporting channel state information (CSI), hybrid automatic repeat request acknowledgement (HARQ-ACK), a buffer status report (BSR), or requesting a scheduling request (SR); or
a repetition factor for one or more of:
the SRS, the CSI-RS, the PTRS, the TRS, the LP-SS, the LP-WUS, the LP-sync-preamble signal, the LP-RS, the HARQ-ACK, and the CSI,
wherein the periodicity configuration comprises one or more of:
a first periodicity for monitoring for the PDCCH with the corresponding radio at the UE;
a second periodicity for monitoring one or more of: the CSI-RS, the TRS, the PTRS, the SRS for the reception at the first radio;
a third periodicity for monitoring the LP-RS or the LP-SS with the second radio; and
a fourth periodicity of reporting the CSI, the HARQ-ACK, the BSR, or requesting the SR,
wherein the bandwidth configuration for the communication of the UE comprises:
a bandwidth for monitoring for at least one of the LP-WUS, the LP-RS, the LP-SS or the LP-sync-preamble signal, or for operating within a bandwidth part (BWP) for the first radio within a corresponding time interval, and
wherein the SCS configuration for the communication of the UE comprises:
an SCS for monitoring for at least one of the LP-WUS, the LP-RS, or the LP-SS, or for operating within the BWP for the first radio within the corresponding time interval, wherein each of the LP-WUS, the LP-RS, the LP-SS and the LP-sync-preamble signal is one of:
a coded control signal, a sequential-based signal, or an OOK-based waveform signal.

11. (canceled)

12. The apparatus of claim 7, wherein communication modes in the sequence of communication modes are associated with one or more of:
different configurations for monitoring one or more of: a low power wake-up signal (LP-WUS), a physical downlink control channel (PDCCH)-based WUS, the LP-RS, the LP-SS, or an LP synchronization preamble (LP-sync-preamble) signal within a corresponding time interval, and
monitoring one or more of: the LP-RS, the LP-SS, or the LP-WUS using a frequency bandwidth associated with each communication mode within the corresponding time interval, wherein frequency bandwidths associated with the communication modes have a shared core frequency band.

13-14. (canceled)

15. The apparatus of claim 7, where the at least one processor is further configured to perform a communication mode selection process with the network entity through one or more of: a layer 1 (L1) signaling, a layer 2 (L2) signaling, a layer 3 (L3) signaling, user-assistance information (UAI), a power headroom report (PHR), a scheduling request (SR), a random-access channel (RACH) message, or hybrid automatic repeat request acknowledgement (HARQ-ACK), and
wherein the communication mode selection process includes one or more of:
indicating, to the network entity, a desired communication mode at a designated time, during a designated time duration, or until a new communication mode is indicated by the UE;
receiving, from the network entity, a second indication of a designated communication mode, wherein the UE is configured to communicate according to the designated communication mode until another communication mode is indicated;
indicating, to the network entity, a desired sequence of communication modes;
receiving, from the network entity, a third indication of a designated sequence of communication modes from multiple sequences of communication modes;
indicating, to the network entity, a desired operating state of one or more of the SW component, the FW component, the HW component, or the RF component of the UE, wherein the desired operating state is one of an ON state or an OFF state;
receiving, from the network entity, a fourth indication of a designated operating state for one or more of the SW component, the FW component, the HW component, or the RF component of the UE, wherein the designated operating state is one of the ON state or the OFF state;
indicating, to the network entity, a desired bandwidth for monitoring for at least one of an LP-WUS, the LP-RS, the LP-SS or an LP-sync-preamble signal, or for operating within a BWP for one of the first radio and the second radio within a corresponding time interval; or
receiving, from the network entity, a designated bandwidth for monitoring for at least one of the LP-WUS, the LP-RS, the LP-SS or the LP-sync-preamble signal, or for operating within the BWP for one of the first radio and the second radio within the corresponding time interval.

16. An apparatus for wireless communication at a network entity, comprising:
memory; and
at least one processor coupled to the memory and configured to:
transmit, to a user equipment (UE), an indication to use one or more communication modes, wherein each of the one or more communication modes is associated with a configuration of at least one of a first radio and a second radio of the UE, the second radio having a lower power consumption than the first radio; and
transmit communication to the UE according to a corresponding communication mode in the one or more communication modes at a time the communication is transmitted to the UE.

17. The apparatus of claim 16, wherein the configuration of at least one of the first radio and the second radio is associated with at least one of:
a sleep mode for at least one of the first radio or the second radio of the UE;
a power mode for at least one of the first radio or the second radio of the UE;
one or more predicted data arrival traffic for at least one of data transmission or data reception by the UE;
at least one of priority, quality-of-service (QoS), and latency of the one or more predicted data arrival traffic for at least one of the data transmission or the data reception by the UE; or
coverage and communications sensitivity requirements of the network entity.

18. The apparatus of claim 16, wherein a communication mode configuration for each of the one or more communication modes includes one or more of:
one or more of an active or inactive software (SW) component, an active or inactive firmware (FW) component, an active or inactive hardware (HW) component, or an active or inactive radio frequency (RF) component to be used by at least one of the first radio or the second radio of the UE;
one or more of discontinuous reception (DRX) configurations to be used by at least one of the first radio or the second radio based on a radio resource control (RRC) state;
one or more of first components in the UE to be used for processing complex signals using the first radio or the second radio;
one or more of second components in the UE to be used for processing polar decoding using the first radio or the second radio;
a capability to process a signal in at least one of a time domain or a frequency domain using the first radio or the second radio;
a time indication for one or more of: performing decoding or detection of a wake-up signal (WUS) or one or more of low power reference signal (LP-RS), low power synchronization signal (LP-SS), low power synchronization preamble (LP-sync-preamble) signal processing using the first radio or the second radio;
PDCCH monitoring occasions on at least one search space group associated with the first radio or the second radio of the UE;
a time and frequency configuration for the communication of the UE associated with one of the first radio or the second radio;
a periodicity configuration for the communication of the UE associated with one of the first radio or the second radio;
a bandwidth configuration for the communication of the UE using the first radio or the second radio;
a subcarrier spacing (SCS) configuration for the communication of the UE using the first radio or the second radio;
a first measurement configuration for radio resource management (RRM) for or more of a serving cell or nearby cells of the UE using the first radio or the second radio;
a second measurement configuration for a relaxation of the RRM for one or more of the serving cell or the nearby cells or for at least one type of an intra-frequency type or an inter-frequency type of the UE using the first radio or the second radio;
a third measurement configuration for allowing an RRM measurement offloading for at least one of serving cell RRM measurements or nearby cells RRM measurements and for at least an RRM measurement type of the inter-frequency type or the intra-frequency type from the first radio to the second radio or from the second radio to the first radio; and
a monitoring configuration for monitoring for one or more of a synchronization signal block (SSB), a system information change, or a system information block (SIB) signal using the first radio or the second radio.

19-20. (canceled)

21. The apparatus of claim 18, wherein the indication comprises a sequence of communication modes, and each communication mode of the sequence of communication modes is associated with a time interval, and wherein to transmit the communication to the UE, the at least one processor is further configured to:
transmit the communication to the UE according to the corresponding communication mode in the sequence of communication modes at the time the communication is transmitted to the UE.

22. The apparatus of claim 21, wherein the at least one processor is further configured to:
receive, from the UE, an expected transition time, wherein the expected transition time is one of:
a first time between adjacent communication modes of the sequence of communication modes, or
a second time between a receiving time the second radio receiving a lower power wake-up signal (LP-WUS) and a wakeup time when the first radio wakes up or is able to monitor the PDCCH monitoring occasions; and
transmit, to the UE, an additional indication for the UE to operate in a transition mode, wherein an actual transition time is set by the UE based on the configuration of the at least one of the first radio and the second radio of the UE.

23. (canceled)

24. The apparatus of claim 21, wherein the time and frequency configuration corresponds to a start symbol within a slot, a number of symbols, start resource element or resource block, and a number of resource elements or blocks, wherein the time and frequency configuration comprises one or more of:
a first configuration for monitoring for a physical downlink control channel (PDCCH) with a corresponding radio at the UE;
a second configuration for monitoring one or more of: a channel state information reference signal (CSI-RS), a tracking reference signal (TRS), a phase tracking reference signal (PTRS), a sounding reference signal (SRS) for reception at the first radio;
a third configuration including:
a WUS configuration for monitoring at least one of a low power wakeup signal (LP-WUS), the LP-RS, or the LP-SS; and
a preamble signal configuration for monitoring a low power synchronization preamble (LP-sync-preamble) signal associated with the LP-WUS with the second radio;
a fourth configuration of reporting channel state information (CSI), hybrid automatic repeat request acknowledgement (HARQ-ACK), a buffer status report (BSR), or requesting a scheduling request (SR); or
a repetition factor for one or more of:
the SRS, the CSI-RS, the PTRS, the TRS, the LP-SS, the LP-WUS, the LP-sync-preamble signal, the LP-RS, the HARQ-ACK, and the CSI,
wherein the periodicity configuration comprises one or more of:
a first periodicity for monitoring for the PDCCH with the corresponding radio at the UE;
a second periodicity for monitoring one or more of: the CSI-RS, the TRS, the PTRS, the SRS for the reception at the first radio;
a third periodicity for monitoring the LP-RS or the LP-SS with the second radio; and
a fourth periodicity of reporting the CSI, the HARQ-ACK, the BSR, or requesting the SR,
wherein the bandwidth configuration for the communication of the UE comprises:
a bandwidth for monitoring for at least one of the LP-WUS, the LP-RS, the LP-SS, or an LP-sync-preamble signal, or for operating within a BWP for the first radio within a corresponding time interval, and
wherein the SCS configuration for the communication of the UE comprises:
an SCS for monitoring for at least one of the LP-WUS, the LP-RS, or the LP-SS, or for operating within the BWP for the first radio within the corresponding time interval, wherein each of the LP-WUS, the LP-RS, the LP-SS and the LP-sync-preamble signal is one of:
a coded control signal, a sequential-based signal, or an OOK-based waveform signal.

25. (canceled)

26. The apparatus of claim 21, wherein communication modes in the sequence of communication modes are associated with one or more of:
different configurations for monitoring one or more of: a lower power wake-up signal (LP-WUS), a physical downlink control channel (PDCCH)-based WUS, the LP-RS, the LP-SS, or an LP synchronization preamble (LP-sync-preamble) signal within a corresponding time interval, and
monitoring one or more of: the LP-RS, the LP-SS, or the LP-WUS using a frequency bandwidth associated with each communication mode within the corresponding time interval, wherein frequency bandwidths associated with the communication modes have a shared core frequency band.

27. (canceled)

28. The apparatus of claim 21, wherein the at least one processor is further configured to perform a communication mode selection process with the UE through one or more of: a layer 1 (L1) signaling, a layer 2 (L2) signaling, a layer 3 (L3) signaling, user-assistance information (UAI), a power headroom report (PHR), a scheduling request (SR), a random-access channel (RACH) message, or hybrid automatic repeat request acknowledgement (HARQ-ACK), and
wherein the communication mode selection process includes one or more of:
receiving, from the UE, a desired communication mode at a designated time, during a designated time duration, or until a new communication mode is indicated by the UE;
indicating, to the UE, a second indication of a designated communication mode, wherein the UE is configured to communicate according to the designated communication mode until another communication mode is indicated;
receiving, from the UE, a desired sequence of communication modes;
indicating, to the UE, a third indication of a designated sequence of communication modes from multiple sequences of communication modes;
receiving, from the UE, a desired operating state of one or more of the SW component, the FW component, the HW component, or the RF component of the UE, wherein the desired operating state is one of an ON state or an OFF state;
indicating, to the UE, a fourth indication of a designated operating state for one or more of the SW component, the FW component, the HW component, or the RF component of the UE, wherein the designated operating state is one of the ON state or the OFF state;
receiving, from the UE, a desired bandwidth for monitoring for at least one of an LP-WUS, the LP-RS, the LP-SS or an LP-sync-preamble signal, or for operating within a BWP for one of the first radio and the second radio within a corresponding time interval; and
indicating, to the UE, a designated bandwidth for monitoring for at least one of the LP-WUS, the LP-RS, the LP-SS or the LP-sync-preamble signal, or for operating within the BWP for one of the first radio and the second radio within the corresponding time interval.

29. A method of wireless communication at a user equipment (UE), comprising:
receiving, from a network entity, an indication to use one or more communication modes, wherein each of the one or more communication modes is associated with a configuration of at least one of a first radio and a second radio of the UE, the second radio having a lower power consumption than the first radio; and
monitoring for communication from the network entity according to the one or more communication modes.

30. (canceled)
